(19) United States
(12) Patent Application Publication
(10) Pub. No.: US 2017/0119114 A1
(43) Pub. Date: May 4, 2017

(54) DUCTILE SINTERED MATERIALS AND METHODS OF FORMING THE SAME

(71) Applicant: Frederick Goldman, Inc., New York, NY (US)

(72) Inventor: Andrew Derrig, Lynbrook, NY (US)

(21) Appl. No.: 15/343,754

(22) Filed: Nov. 4, 2016

Related U.S. Application Data
(60) Provisional application No. 62/250,943, filed on Nov. 4, 2015.

(51) Int. Cl. A44C 27/00; A44C 5/00; A44C 25/00; A44C 9/00; A44C 15/00; C04B 35/56; A44C 7/00

(52) U.S. Cl. CPC A44C 27/006; C04B 35/5626; A44C 5/00; A44C 7/00; A44C 9/00; A44C 15/005; A44C 25/001; A44C 25/007; A44C 15/009; A44C 15/0065; C04B 2235/3817; C04B 2235/3839; C04B 2235/3847; C04B 2235/786; C04B 2235/9669

(57) ABSTRACT

Article(s) are disclosed that are formed, at least in part, by a cemented carbide composition having about 8 to about 35 wt. % Co and about 0.8 to about 3.5 wt. % Cr.

### CROSS-REFERENCE TO RELATED APPLICATIONS

The present application claims the benefit of U.S. Provisional Application Ser. No. 62/250,943 filed 4 Nov. 2015; which is incorporated herein by reference in its entirety.

### BACKGROUND

The present application generally relates to compositions of matter and articles of manufacture, such as jewelry items, and methods for their production.

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

Jewelry such as finger rings, pendants, bracelets, and necklaces have traditionally been made of soft metals such as gold, silver and platinum because those metals are malleable, and easily formed by casting, forging and molding. Recently, jewelry items have been formed from harder materials such as alloys or composites such as “cemented carbides.” An alloy is a mixture or metallic solid solution composed of two or more elements. A cemented carbide is a composite material composed of a metal where carbide particles act as the aggregate and a metallic binder serves as the matrix. The carbide particles are typically combined with the binder through sintering.

Some specific attempts to form jewelry from cemented carbides, such as tungsten carbide, include U.S. Pat. Nos. 6,553,667; 6,990,736; 6,993,842; 7,032,314; and 7,076,972. Such jewelry is much more resistant to scratching and other damage than traditional jewelry made of softer metals.

Additional compositions providing desirable jewelry characteristics would be advantageous. The articles provided herewith address that need. In particular, conventional jewelry materials can possess one or more of the following deficiencies and/or disadvantages:
traditional cemented carbide formulations can be too brittle;
traditional cemented carbide formulations may include nickel, which can act as an allergen for persons wearing such articles on or close to their skin;

and
traditional cobalt-chromium cemented carbide formulations may prove difficult or impossible to remove by fracture from the body of the wearer in the event of an emergency.

While certain aspects of conventional technologies have been discussed to facilitate the present disclosure, Applicants in no way disclaim these technical aspects, and it is contemplated that the claims may encompass or include one or more of the conventional technical aspects discussed herein.

### SUMMARY

It has been discovered that articles, including jewelry articles and components of jewelry articles, made, at least in part, from certain chromium-cobalt (Cr—Co) based cemented carbide compositions, such as, for example, cemented carbide compositions having about 0.0 to about 3.5 wt. % Cr and about 10 to about 35 wt. % Co, among other constituents, which will be described in further detail herein, according to certain embodiments, possess unique combinations of desirable features. For example, cemented carbide compositions formed according to the principles of the present disclosure possess desirable hardness, toughness, ductility, machinability, coatability, density, and/or aesthetic properties, that make them particularly attractive for use in forming certain articles, such as jewelry articles and components of jewelry articles.

In an embodiment, cemented carbide compositions are formulated with about 0.0 to about 3.5 wt. % Cr and about 10 to about 35 wt. % Co with no additional constituents. In another embodiment, cemented carbide compositions are formulated with about 1.5 to about 3.5 wt. % Cr and about 10 to about 35 wt. % Co with no additional constituents. In another embodiment, cemented carbide compositions are formulated with about 1.5 to about 3.5 wt. % Cr and about 30 to about 35 wt. % Co with no additional constituents. In another embodiment, cemented carbide compositions are formulated with about 0.0 wt. % Cr, about 0.1 wt. % Cr, about 0.2 wt. % Cr, about 0.3 wt. % Cr, about 0.4 wt. % Cr, about 0.5 wt. % Cr, about 0.6 wt. % Cr, about 0.7 wt. % Cr, about 0.8 wt. % Cr, about 0.9 wt. % Cr, about 1.0 wt. % Cr, about 1.1 wt. % Cr, about 1.2 wt. % Cr, about 1.3 wt. % Cr, about 1.4 wt. % Cr, about 1.5 wt. % Cr, about 1.6 wt. % Cr, about 1.7 wt. % Cr, about 1.8 wt. % Cr, about 1.9 wt. % Cr, about 2.0 wt. % Cr, about 2.1 wt. % Cr, about 2.2 wt. % Cr, about 2.3 wt. % Cr, about 2.4 wt. % Cr, about 2.5 wt. % Cr, about 2.6 wt. % Cr, about 2.7 wt. % Cr, about 2.8 wt. % Cr, about 2.9 wt. % Cr, about 3.0 wt. % Cr, about 3.1 wt. % Cr, about 3.2 wt. % Cr, about 3.3 wt. % Cr, about 3.4 wt. % Cr, or about 3.5 wt. % Cr, and with about 8 wt. % Co, about 9 wt. % Co, about 10 wt. % Co, about 11 wt. % Co, about 12 wt. % Co, about 13 wt. % Co, about 14 wt. % Co, about 15 wt. % Co, about 16 wt. % Co, about 17 wt. % Co, about 18 wt. % Co, about 19 wt. % Co, about 20 wt. % Co, about 21 wt. % Co, about 22 wt. % Co, about 23 wt. % Co, about 24 wt. % Co, about 25 wt. % Co, about 26 wt. % Co, about 27 wt. % Co, about 28 wt. % Co, about 29 wt. % Co, about 3 wt. % Co, about 31 wt. % Co, about 32 wt. % Co, about 33 wt. % Co, about 34 wt. % Co, or about 35 wt. % Co, and with no additional constituents.

In another embodiment, cemented carbide compositions are formulated with about 0.0-3.5 wt. % Cr and about 10-35 wt. % Co with additional constituents selected from Ti, Nb, Ta, boride, nitride Ta, Mo, V, Zr, Hf, Re, Ru, Rh, Os, Ir, Pt, Au, Ag, Fe or other rare earth elements. In another embodiment, cemented carbide compositions are formulated with about 0.0-3.5 wt. % Cr and about 30-35 wt. % Co with additional constituents selected from Ti, Nb, Ta, boride, nitride, boride, nitride Ta, Mo, V, Zr, Hf, Re, Ru, Rh, Os, Ir, Pt, Au, Ag, Fe or other rare earth elements. In another embodiment, cemented carbide compositions are formulated with about 0.0 wt. % Cr, about 0.1 wt. % Cr, about 0.2 wt. % Cr, about 0.3 wt. % Cr, about 0.4 wt. % Cr, about 0.5 wt. % Cr, about 0.6 wt. % Cr, about 0.7 wt. % Cr, about 0.8 wt. % Cr, about 0.9 wt. % Cr, about 1.0 wt. % Cr, about 1.1 wt. % Cr, about 1.2 wt. % Cr, about 1.3 wt. % Cr, about 1.4 wt. % Cr, about 1.5 wt. % Cr, about 1.6 wt. % Cr, about 1.7 wt. % Cr, about 1.8 wt. % Cr, about 1.9 wt. % Cr, about 2.0 wt. % Cr, about 2.1 wt. % Cr, about 2.2 wt. % Cr, about 2.3 wt. % Cr, about 2.4 wt. % Cr, about 2.5 wt. % Cr, about 2.6 wt. % Cr, about 2.7 wt. % Cr, about 2.8 wt. % Cr, about 2.9 wt. % Cr, about 3.0 wt. % Cr, about 3.1 wt. % Cr, about 3.2 wt. % Cr, about 3.3 wt. % Cr, about 3.4 wt. % Cr, or about 3.5 wt. % Cr, and with about 8 wt. % Co, about 9 wt. % Co, about 10 wt. % Co, about 11 wt. % Co, about 12 wt. % Co, about 13 wt. % Co, about 14 wt. % Co, about 15 wt. % Co, about 16 wt. % Co, about 17 wt. % Co, about 18 wt. % Co, about 19 wt. % Co, about 20 wt. % Co, about 21 wt. % Co, about 22 wt. % Co, about 23 wt. % Co, about 24 wt. % Co, about 25 wt. % Co, about 26 wt. % Co, about 27 wt. % Co, about 28 wt. % Co, about 29 wt. % Co, about 3 wt. % Co, about 31 wt. % Co, about 32 wt. % Co, about 33 wt. % Co, about 34 wt. % Co, or about 35 wt. % Co, and with one or more additional constituents selected from Ti, Nb, boride, nitride, Ta, Mo, V, Zr, Hf, Re, Ru, Rh, Os, Ir, Pt, Au, Ag, Fe, or other rare earth elements.

In another embodiment, cemented carbide compositions are formulated with about 0.0 to about 3.5 wt. % Cr and about 10 to about 35 wt. % Co with additional constituents comprising boride and/or nitride. In another embodiment, cemented carbide compositions are formulated with about 0.0 to about 3.5 wt. % Cr and about 10 to about 35 wt. % Co and with less than about 90 wt. % WC. In another embodiment, cemented carbide compositions are formulated with about 0.0 to about 3.5 wt. % Cr and about 30 to about 35 wt. % Co and with less than about 90 wt. % WC. In another embodiment, cemented carbide compositions are formulated with about 0.0 wt. % Cr, about 0.1 wt. % Cr, about 0.2 wt. % Cr, about 0.3 wt. % Cr, about 0.4 wt. % Cr, about 0.5 wt. % Cr, about 0.6 wt. % Cr, about 0.7 wt. % Cr, about 0.8 wt. % Cr, about 0.9 wt. % Cr, about 1.0 wt. % Cr, about 1.1 wt. % Cr, about 1.2 wt. % Cr, about 1.3 wt. % Cr, about 1.4 wt. % Cr, about 1.5 wt. % Cr, about 1.6 wt. % Cr, about 1.7 wt. % Cr, about 1.8 wt. % Cr, about 1.9 wt. % Cr, about 2.0 wt. % Cr, about 2.1 wt. % Cr, about 2.2 wt. % Cr, about 2.3 wt. % Cr, about 2.4 wt. % Cr, about 2.5 wt. % Cr, about 2.6 wt. % Cr, about 2.7 wt. % Cr, about 2.8 wt. % Cr, about 2.9 wt. % Cr, about 3.0 wt. % Cr, about 3.1 wt. % Cr, about 3.2 wt. % Cr, about 3.3 wt. % Cr, about 3.4 wt. % Cr, or about 3.5 wt. % Cr, and with about 8 wt. % Co, about 9 wt. % Co, about 10 wt. % Co, about 11 wt. % Co, about 12 wt. % Co, about 13 wt. % Co, about 14 wt. % Co, about 15 wt. % Co, about 16 wt. % Co, about 17 wt. % Co, about 18 wt. % Co, about 19 wt. % Co, about 20 wt. % Co, about 21 wt. % Co, about 22 wt. % Co, about 23 wt. % Co, about 24 wt. % Co, about 25 wt. % Co, about 26 wt. % Co, about 27 wt. % Co, about 28 wt. % Co, about 29 wt. % Co, about 3 wt. % Co, about 31 wt. % Co, about 32 wt. % Co, about 33 wt. % Co, about 34 wt. % Co, or about 35 wt. % Co, and with one or more additional constituents comprising less than about 90 wt. % WC.

In another embodiment, cemented carbide compositions are formulated with from about 10 to about 35 wt. % Co and no Cr. In another embodiment, cemented carbide compositions are formulated with from about 30 to about 35 wt. % Co and no Cr. In yet another embodiment, cemented carbide compositions are formulated with from about 15 to about 30 wt. Co and no Cr. In another embodiment, cemented carbide compositions are formulated with from about 8 wt. % Co, about 9 wt. % Co, about 10 wt. % Co, about 11 wt. % Co, about 12 wt. % Co, about 13 wt. % Co, about 14 wt. % Co, about 15 wt. % Co, about 16 wt. % Co, about 17 wt. % Co, about 18 wt. % Co, about 19 wt. % Co, about 20 wt. % Co, about 21 wt. % Co, about 22 wt. % Co, about 23 wt. % Co, about 24 wt. % Co, about 25 wt. % Co, about 26 wt. % Co, about 27 wt. % Co, about 28 wt. % Co, about 29 wt. % Co, about 3 wt. % Co, about 31 wt. % Co, about 32 wt. % Co, about 33 wt. % Co, about 34 wt. % Co, or about 35 wt. % Co, and no Cr. In another embodiment, cemented carbide compositions are formulated with from about 10-35 wt. % Co and no Cr but with one or more additional constituents such as boride, nitride Ta, Mo, V, Zr, Hf, Re, Ru, Rh, Os, Ir, Pt, Au, Ag, Fe or other rare earth elements. In another embodiment, cemented carbide compositions are formulated with from about 30-35 wt. % Co and no Cr but with one or more additional constituents such as a boride, nitride Ta, Mo, V, Zr, Hf, Re, Ru, Rh, Os, Ir, Pt, Au, Ag, Fe or other rare earth elements. In another embodiment, cemented carbide compositions are formulated with from about 8 wt. % Co, about 9 wt. % Co, about 10 wt. % Co, about 11 wt. % Co, about 12 wt. % Co, about 13 wt. % Co, about 14 wt. % Co, about 15 wt. % Co, about 16 wt. % Co, about 17 wt. % Co, about 18 wt. % Co, about 19 wt. % Co, about 20 wt. % Co, about 21 wt. % Co, about 22 wt. % Co, about 23 wt. % Co, about 24 wt. % Co, about 25 wt. % Co, about 26 wt. % Co, about 27 wt. % Co, about 28 wt. % Co, about 29 wt. % Co, about 3 wt. % Co, about 31 wt. % Co, about 32 wt. % Co, about 33 wt. % Co, about 34 wt. % Co, or about 35 wt. % Co, and no Cr but with one or more additional constituents comprising at least one of boride, nitride Ta, Mo, V, Zr, Hf, Re, Ru, Rh, Os, Ir, Pt, Au, Ag, Fe or other rare earth elements.

In an embodiment, the cemented carbide compositions are manufactured utilizing a metal injection molding (MIM) technique. In another embodiment, the cemented carbide compositions are manufactured utilizing a lost wax molding process. In still another embodiment, the cemented carbide compositions are manufactured utilizing a sintered technique. In still another embodiment, the cemented carbide compositions are manufactured utilizing an investment casting technique.

In an embodiment, cemented carbide compositions are formulated with about 0.0 to about 3.5 wt. % Cr and about 10 to about 35 wt. % Co and the remainder of the composition, for example, the binder or other portion of the article, optionally comprises one or more of: Ta, Nb, Mo, Ti, V, Zr, Hf, Re, Ru, Rh, Os, Ir, Pt, Au, Ag, and/or Fe.

In an embodiment, cemented carbide compositions are formulated with about 1.0 to about 3.5 wt. % Cr and about 10 to about 35 wt. % Co and the remainder of the composition, for example, the binder or other portion of the article, optionally comprises one or more of: Ta, Nb, Mo, Ti, V, Zr, Hf, Re, Ru, Rh, Os, Ir, Pt, Au, Ag, and/or Fe.

In another embodiment, cemented carbide compositions are formulated with about 0.0 to about 3.5 wt. % Cr and about 10 to about 35 wt. % Co and the remainder of the composition, for example, the binder or other portion of the article, comprises may optionally have one or more of: Ta, Nb, Mo, Ti, V, Zr, Hf, Re, Ru, Rh, Os, Ir, Pt, Au, Ag, and/or Fe. In another embodiment, cemented carbide compositions are formulated with about 1.0 to about 3.5 wt. % Cr and about 10 to about 35 wt. % Co and the remainder of the composition, for example, the binder or other portion of the article, comprises may optionally have one or more of: Ta, Nb, Mo, Ti, V, Zr, Hf, Re, Ru, Rh, Os, Ir, Pt, Au, Ag, and/or Fe. In another embodiment, cemented carbide compositions are formulated with about 0.0 to about 3.5 wt. % Cr and about 30 to about 35 wt. % Co and the remainder of the composition, for example, the binder or other portion of the article, comprises one or more of: Ta, Nb, Mo, Ti, V, Zr, Hf, Re, Ru, Rh, Os, Ir, Pt, Au, Ag, and/or Fe. In another embodiment, cemented carbide compositions are formulated with about 0.0 wt. % Cr, about 0.1 wt. % Cr, about 0.2 wt. % Cr, about 0.3 wt. % Cr, about 0.4 wt. % Cr, about 0.5 wt. % Cr, about 0.6 wt. % Cr, about 0.7 wt. % Cr, about 0.8 wt. % Cr, about 0.9 wt. % Cr, about 1.0 wt. % Cr, about 1.1 wt. % Cr, about 1.2 wt. % Cr, about 1.3 wt. % Cr, about 1.4 wt. % Cr, about 1.5 wt. % Cr, about 1.6 wt. % Cr, about 1.7 wt. % Cr, about 1.8 wt. % Cr, about 1.9 wt. % Cr, about 2.0 wt. % Cr, about 2.1 wt. % Cr, about 2.2 wt. % Cr, about 2.3 wt. % Cr, about 2.4 wt. % Cr, about 2.5 wt. % Cr, about 2.6 wt. % Cr, about 2.7 wt. % Cr, about 2.8 wt. % Cr, about 2.9 wt. % Cr, about 3.0 wt. % Cr, about 3.1 wt. % Cr, about 3.2 wt. % Cr, about 3.3 wt. % Cr, about 3.4 wt. % Cr, or about 3.5 wt. % Cr, and with about 8 wt. % Co, about 9 wt. % Co, about 10 wt. % Co, about 11 wt. % Co, about 12 wt. % Co, about 13 wt. % Co, about 14 wt. % Co, about 15 wt. % Co, about 16 wt. % Co, about 17 wt. % Co, about 18 wt. % Co, about 19 wt. % Co, about 20 wt. % Co, about 21 wt. % Co, about 22 wt. % Co, about 23 wt. % Co, about 24 wt. % Co, about 25 wt. % Co, about 26 wt. % Co, about 27 wt. % Co, about 28 wt. % Co, about 29 wt. % Co, about 3 wt. % Co, about 31 wt. % Co, about 32 wt. % Co, about 33 wt. % Co, about 34 wt. % Co, or about 35 wt. % Co, and the remainder of the composition, for example, the binder or other portion of the article, optionally comprises one or more of: Ta, Nb, Mo, Ti, V, Zr, Hf, Re, Ru, Rh, Os, Ir, Pt, Au, Ag, and/or Fe.

In an embodiment, in addition to Co and Cr, the remainder of the composition, for example, the binder or other portion of the article, optionally comprises one or more of: Ta, Nb, Mo, Ti, V, Zr, Hf, Re, Ru, Rh, Os, Ir, Pt, Au, Ag, and/or Fe.

In one or more embodiment, the article includes one or more materials, including, without limitation, one or more of Ta, Nb, Mo, Ti, V, Zr, Hf, Re, Ru, Rh, Os, or Ir used to form a cermet, or a carbide, boride, and/or nitride based composition.

In an embodiment, compositions, and articles, including jewelry articles and components of jewelry articles, formed at least in part thereby, according to the certain embodiments of the present disclosure, are substantially free of nickel.

Compositions, and articles, including jewelry articles and components of jewelry articles, formed at least in part thereby, according to certain embodiments of the present disclosure, include one or more rare earth metals, cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), or yttrium (Y), Actinium, Thorium, Protactinium, Uranium, Neptunium, Plutonium, Americium, Curium, Berkelium, Californium, Einsteinium, Fermium, Mendelevium, Nobelium, Lawrencium.

In some embodiments, an article formed according to the principles of the present disclosure further possesses a density of about 10.00 to about 15.00 g/cm³. By way of non-limiting example, according to certain optional embodiments the following compositions possess the following density values.

| % of Cobalt | |
|---|---|
| Binder | gm/cm³ |
| 35 | 12.14 |
| 30 | 12.72 |
| 22 | 13.30 |
| 20 | 13.32 |

In some embodiments, an article formed according to the principles of the present disclosure further possesses a hardness of about 900HV to about 1150HV.

In other embodiments, an article formed according to the principles of the present disclosure further possesses a hardness of about 700HV to about 1400HV or about 800HV to about 1400HV.

In some embodiments, an article formed according to the principles of the present disclosure further possesses a cracking load of no more than about 1000 lbf.

In some embodiments, an article formed according to the principles of the present disclosure optionally possesses a coloration characterized by L*, a*, b* values of about L*48.5, about a*0.77, and about b*3.7 where L*is the black-white range where a L*=0 yields black and a L*of 100 indicates a diffuse white; a* is the green-magenta scale where negative values indicate green while positive values indicate magenta; and b*is the blue to yellow range where negative values indicate blue and positive values indicate yellow.

In some embodiments, an article formed according to the principles of the present disclosure are characterized as having an average grain size of preferably about 2 to about 4 μm and more preferably about 1.4 μm to about 2.0 μm, as measured using ASTM390-92(06).

In some embodiments, an article formed according to the principles of the present disclosure possesses a corrosion resistance, when tested utilizing Salt Spray (ASTM B117, ISO 9227).

In some embodiments, an article formed according to the principles of the present disclosure possess an abrasion resistance.

In some embodiments, the article is in the form of an item of jewelry.

In some embodiments, the jewelry article or component of the jewelry article is a ring, ornamental ring, engagement ring, toe ring, watch, watchcase, bracelet, necklace, pendant, electronic accessories, charm, armlet, brocade, pin, clip, hairclip, fob, ornamental piercing, earring, nose ring, dog tag, chain, amulet, bangle bracelet, cuff bracelet, link bracelet, cuff link, key chain, money clip, cell phone charm, signet ring, class ring, friendship ring or purity ring or a component any of the foregoing.

In some embodiments, the article is in the form of a finger ring.

In some embodiments, the article includes at least one of a precious metal, a stone, a gemstone, a crystal, or another material suitable for use in jewelry affixed to the article.

In some embodiments, the article includes one or more coatings, including coatings as described and disclosed in U.S. Pat. Nos. 8,927,107, 8,932,437, 8,956,510, and 9,034,488, and in U.S. patent application Ser. Nos. 13/152,226, 14/166,776, 14/589,924, and 14/715,556, each of which is incorporated herein in its entirety for all purposes.

In some embodiments, one or more of the problems and deficiencies of the prior art discussed above are addressed. However, it is contemplated that certain embodiments are useful in addressing other problems and deficiencies, or provide benefits and advantages, in a number of technical areas. Therefore the claims should not necessarily be construed as being limited to addressing any of the particular problems or deficiencies discussed herein.

### BRIEF DESCRIPTION OF THE DRAWINGS

FIG. 1 is a perspective view of a finger ring in accordance with an illustrative embodiment of the present disclosure.

FIGS. 2A and 2B are perspective views of finger rings made from the composition of the present disclosure, according to additional embodiments of the present disclosure.

FIG. 3 is an embodiment of a finger ring with inlay made from the compositions of the present disclosure.

FIG. 4 shows an embodiment of a finger ring made from the compositions of the present disclosure with inlays of precious metals and stones.

FIGS. 5A and 5B illustrate apparent grain size in various samples of a cemented carbide jewelry article made in accordance with the present disclosure.

FIG. 6 is a graph showing a comparison between the color values for samples of BC-30 and Tungsten samples, in accordance with the present disclosure.

### DETAILED DESCRIPTION

As used herein, the singular forms “a”, “an” and “the” are intended to include the plural forms as well, unless the context clearly indicates otherwise. Additionally, the use of “or” is intended to include “and/or”, unless the context clearly indicates otherwise.

As used herein, “about” is a term of approximation and is intended to include minor variations in the literally stated amounts, as would be understood by those skilled in the art. Such variations include, for example, standard deviations associated with techniques commonly used to measure the amounts of the constituent elements or components of a composition or composite material, or the properties possessed by an article formed from such compositions. The term “about” and/or “substantially” refers to and includes a +/−10% variation from the nominal value/term. Such variation is always included in any given value/term provided herein, whether or not such variation is specifically referred thereto

All of the numerical values contained in this disclosure are to be construed as being characterized by the above-described modifier “about,” are also intended to include the exact numerical values disclosed herein. The ranges disclosed herein should be construed to encompass all values within the upper and lower limits of the ranges, unless indicated otherwise. Moreover, all ranges include the upper and lower limits.

As used herein, “substantially free of nickel” means that nickel is not intentionally added to the composition as a constituent additive, but does not necessarily exclude the presence of trace or impurity levels of nickel within the composition. By way of example only, trace amounts on the order of about 0.062 wt. % Ni, or less, may be present in the composition.

All percentages disclosed herein refer to percent by weight, relative to the overall weight of the composition, unless otherwise described herein. The weight percentages disclosed herein may be measured by an Inductively Coupled Mass Spectrometry (“ICP-MS”). ICP- is a type of mass spectrometry which is capable of detecting metals and several non-metals at concentrations as low as one part in 10¹⁵ (part per quadrillion, ppq) on non-interfered low-background isotopes. This is achieved by ionizing the sample with inductively coupled plasma and then using a mass spectrometer to separate and quantify those ions. The sample is ionized by inductively coupled plasma and then the ions are separated and quantified by a mass spectrometer. When this is used to analyze materials comprising cemented carbon, carbon may appear in the analyzed results. Carbon may be detected by LECO 744 Series: Carbon and sulfur in inorganic material by the combustion infrared Detection technique. This may be performed in accordance with ASTM E1019 and ASTM E1409, LECO Combustion Analysis methods include: CARBON & SULFUR ANALYSIS which may include weighing the material, and heating and combusting in the presence of pure oxygen. During the process, carbon and sulfur are oxidized to form CO2 and SO2 which may be measured.

In various samples formulated using the various embodiments, chemical analysis was performed for samples BC-30 and BC-35. As used herein BC-30 and BC-35 refer to samples using 30% and 35% cobalt based binder respectively. Some examples are shown in Table 1.

TABLE 1
Chemical Analysis (Wt %)

| Element | Sample BC-30 | Sample BC-35 |
|---|---|---|
| Silicon | 0.07 | 0.05 |
| Iron | <0.01 | 0.02 |
| Copper | — | — |
| Manganese | 0.02 | 0.02 |
| Nickel | 0.01 | 0.01 |
| Cobalt | 26.20 | 29.53 |
| Potassium | 0.02 | 0.02 |
| Chromium | 1.55 | 1.30 |
| Titanium | 1.17 | 1.32 |
| Tantalum | 0.05 | 0.05 |
| Carbon | 3.73 | 3.65 |
| Sulfur | <0.01 | <0.01 |
| Tungsten | Balance | Balance |
| Density (g/ml) | 12.845 | 12.563 |

The reported density values are measured according to conventional gravimetric techniques as detailed in ASTM B311-13.

The “HV” hardness number values described herein refer to the hardness value measured according to the Vickers hardness test, performed according to the ASTM:E384-11^{ε1} standard (last revised March 2012) see www.astm.org, and incorporated herein by reference in its entirety.

This test method covers determination of the Knoop and Vickers hardness of materials, the verification of Knoop and Vickers hardness testing machines, and the calibration of standardized Knoop and Vickers test blocks. This test method covers Knoop and Vickers hardness tests made utilizing test forces in micro (9.807×10-3 to 9.807 N) (1 to 1000 gf) and macro (>9.807 to 1176.80 N) (>1 kg to 120 kgf) ranges. This test method includes all of the requirements to perform macro Vickers hardness tests as previously defined in Test Method E92, Standard Test Method for Vickers Hardness Testing.

Hardness tests have been found to be very useful for materials evaluation, quality control of manufacturing processes and research and development efforts. Hardness, although empirical in nature, can be correlated to tensile strength for many metals, and is an indicator of wear resistance and ductility. Microindentation hardness tests extend testing to materials that are too thin or too small for macroindentation hardness tests. Microindentation hardness tests also allow specific phases or constituents and regions or gradients too small for macroindentation hardness testing to be evaluated.

Because the Knoop and Vickers hardness will reveal hardness variations that may exist within a material, a single test value may not be representative of the bulk hardness. The Vickers indenter usually produces a geometrically similar indentation at all test forces. Except for tests at very low forces that produce indentations with diagonals smaller than about 25 μm, the hardness number will be essentially the same as produced by Vickers machines with test forces greater than 1 kgf, as long as the material being tested is reasonably homogeneous. For isotropic materials, the two diagonals of a Vickers indentation are equal in size. The Knoop indenter does not produce a geometrically similar indentation as a function of test force. Consequently, the Knoop hardness will vary with test force. Due to its rhombic shape, the indentation depth is shallower for a Knoop indentation compared to a Vickers indentation under identical test conditions. The two diagonals of a Knoop indentation are markedly different. Ideally, the long diagonal is 7.114 times longer than the short diagonal, but this ratio is influenced by elastic recovery. Thus, the Knoop indenter is very useful for evaluating hardness gradients or thin coatings of sectioned samples.

The reported “cracking load” values are measured according to the following methodology. In an embodiment, crack load testing was performed on BC-30 using a Stuller ring cracker. The ring cracker was applied to the ring and after additional power was supplied, the BC-30 sample flexed significantly before cracking into 3-4 pieces. The pieces did not shatter in shards but after the test, slight mars or indentations could be seen on the surface of the BC-30 parts. In another crack test, standard vise-grip or locking pliers are used to apply the force to the ring. In the BC-30 vise grip test, the locking mechanism was hand tightened with significant pressure. The ring itself cracked into a few pieces with generally no sharp edges. The ring did not splinter into shards. When testing with the same vise-grip method on TC850 ring, the sample cracked in many small shards having sharp edges.

In an embodiment, various specimens are subjected to crack testing resulting in the performance identified in Table 2.

TABLE 2
CONFORMANCE/NONCONFORMANCE/AS REPORTED: As Reported

| CUSTOMER SPECIMEN ID: | BC-30 | TC-850 |
|---|---|---|
| PES SPECIMEN ID: | H576 | H577 |
| Original Specimen Width (inches) | 0.327 | 0.313 |
| Original Specimen Thickness (inches) | 0.0868 | 0.0952 |
| Weak Load (lbf) | 746 | 627 |
| Ultimate Compressive Strength (ksi) | 13.1 | 10.5 |
| Test Comment Code(s) | N | N |

An Intron 4206 30K Universal testing machine was used for load testing. Load or compression testing included applying an increasing amount of pressure to an annular part of a given geometry of the object, (i.e.: cross sectional thickness and volume) at a fixed head speed (0.05″/min). The test measured and recorded the amount of pressure at which the object begin to deform and the amount of pressure it took for the object to crack. The objective of the test was to compare the test results against materials of different composition, in an embodiment that included different binder percentages and make up. The results illustrated the increased ductility and overall toughness of the material as compared to standard formulations.

As used herein, “L,” “a,” and “b,” refer to the color values measured according to the CIE 1976 (L*, a*, b*) color space (or CIELAB) scale. These values disclosed herein were measured by a Konica Minolta Spectrophotometer model CM-600. In an embodiment, as shown in Table 3, the following values were obtained for various samples.

TABLE 3

| | Data Name | L*(D65) | a*(D65) | b*(D65) |
|---|---|---|---|---|
| Target | Averaged Target BC-30 | 48.5 | 0.77 | 3.7 |
| | Data Name | L*(D65) | a*(D65) | b*(D65) |
| Target | Averaged Target TC850 | 79.12 | 0.82 | 5.02 |
| | Data Name | L*(D65) | a*(D65) | b*(D65) |
| Target | Averaged Target Cobalt | 80.61 | 1.05 | 5.89 |
| | Data Name | L*(D65) | a*(D65) | b*(D65) |
| Target | Averaged Target White | 8.25 | 0.75 | 5.03 |
| | Data Name | L*(D65) | a*(D65) | b*(D65) |
| Target | Averaged Target Black | 29.37 | 0.25 | 1.69 |
| | Data Name | L*(D65) | a*(D65) | b*(D65) |
| Target | Averaged Target Yellow | 86.72 | 6.1 | 31.19 |
| | Data Name | L*(D65) | a*(D65) | b*(D65) |
| Target | Averaged Target Rose | 85.31 | 14.76 | 25.94 |

In an embodiment L*48.5, a*0.77, b*3.7 were the values measured on an average target BC-30 object.

The average grain sizes reported herein are measured according to the ASTM E112-113 “Standard Test Methods for Determining Average Grain Size” adopted in 2013 and incorporated herein by reference in its entirety. In an embodiment, the average grain size was preferably about 2-4 μm and more preferably about 1.4 μm-2.0 μm as measured using ASTM390-92(06)

The corrosion resistance values described herein are measured according to the ASTM B-117, ISO9227 standard technique.

The abrasion resistance values described herein are measured according to the ASTM D4060 standard.

All of the stated compositions and methods disclosed herein are to be construed as “comprising,” “consisting essentially of,” and “consisting of” the stated constituents and method steps.

Articles, including jewelry articles and components of jewelry articles, formed according to the principles of the present disclosure can be formed, at least in part, from a particular composition.

According to further alternative embodiments, the composition is selected from a combination of one or more, or all, elements listed in the table below, in any of the amounts described in Table 4.

TABLE 4

| | Relative amounts in wt. %, modified in all |
|---|---|
| Constituent | cases by the term “about” |
| Co | 10-35%, 8%, 10%, 15%, 20%, 22%, 25%, 30% or 35% |
| Cr | 0-5%, 0.8%, 1.0%, 1.5%, 2.0%, 2.2%, 3.0%, 3.5%, 4%, |
| | 4.5% of 5% |
| C | 3% and 6.5%, 3%, 3.5%, 4%, 4.5%, 5%, 5.5%, 6%, 6.5% |
| Ta | <1%,(0 to 1%).10%, .25%, .75% or 1% |
| Ti | <1% (0 to 1%) .10%, .25%, .75% or 1% |
| Fe | <1%, (0 to 1%).10%, .25%, .75% or 1% |
| W | 40%-90%, 40%, 50%, 60%, 70%, 80%, 90% |
| Ni | <1% (0 to 1%) .10%, .25%, .75% or 1% |
| Si | <1%,. (0 to 1%), 10%, .25%, .75% or 1% |
| Mn | 0 to 1% .10%, .25%, .75% or 1% |
| K | 0 to 1% .10%, .25%, .75% or 1% |
| S | <1%, (0 to 1%), .10%, .25%, .75% or 1% |

Trace amounts of the following materials can be included in certain embodiments of the composition: Silicon, Manganese, Potassium, Copper, Sulfur, Nickel, Niobium, Molybdenum, Vandium, Zirconium, Hafnium, Rhenium, Ruthenium, Rhodium, Osmium and Iridium and other rare earth elements. In certain embodiment, the trace amounts may be about 0.0 to about 1.0 wt. % of the composition.

With respect to Co, the composition may include about 10 to about 35 wt. % of Co. Amounts of Co significantly below lower limit are not preferred because of the increased brittleness as a result of lower metallic binder content. Compositions that include Co in amounts above the upper limit of this range are not preferred because they will be too ductile and difficult to sinter, and not have the right balance of toughness and abrasion resistance.

With respect to Cr, the composition may include about 1.0 to about 5 wt. % Cr. Amounts of Cr significantly below lower limit are not preferred because the composition will not have oxidation resistance needed for daily consumer product usage. Compositions that include Cr in amounts above the upper limit of this range are not preferred because of increased grain growth, brittleness, and ETA phase.

With respect to Ni, the composition is preferably substantially free of nickel. In addition, or in the alternative, the compositions of the present disclosure may be formulated to comply with the EN1811/2011 standard for products intended to come into direct and prolonged contact with the skin.

Carbon exists in the composition in the form of a carbide with Cr (CrₓC_{y}). Various carbide forms are contemplated, including one or more of: Cr₃C₂, Cr₇C₃, and/or Cr₂₃C₆. With respect to C, the composition may include about 3.0 to about 6.5 wt. % C. Amounts of C significantly below this lower limit are not preferred because the tungsten component will not be properly carburized for best performance. Compositions that include C in amounts above the upper limit of this range are not preferred because of brittleness, ETA Phase, and over carburization.

Compositions formed according to the principles of the present disclosure may include, in addition to the above-described elements, one or more of the following constituent elements, alone or in any combination: Ta, Nb, Mo, Ti, V, Zr, Hf, Re, Ru, Rh, Os, Ir, Pt, Au, Ag and/or Fe.

In an embodiment, rare earth additions (dopants) may be added to the primary materials and binders. Rare earth additions may provide desirable properties to the objects and may be added to the manufacturing process in any known way. Rare earth additives have been investigated and developed for mass production due to their obvious physical and mechanical properties such as hardness, transverse rupture strength, impact toughness, wear resistance, cutting life and so on. The studies on rare-earth doped cemented carbides in China including manufacturing techniques are reviewed in the “Study on rare-earth doped cemented carbides in China” by Liu Sha as reported in the Int. Journal of Refractory Metals & Hard Materials 27 (2009) 528-243, incorporated herein by reference in its entirety.

In some embodiment, the rare earth dopants include Lanthanum (La), Yttrium (Y), Samarium (Sm), NeoDynium (Nd), Cerium (Ce), PraseoDymium (Pr), and Gadolimium (Gd).

In some embodiments, the object composition may be broken down into three phases Alpha, Beta and Gamma, where Alpha (α) is the primary material such as WC, Beta (β) is a metallic binder such as Co or Ni, and Gamma (γ) is any ancillary additives such as TiC or TaC. In some embodiments, the γ phase may be broken into multiple phases.

In certain embodiments, objects made from the following formulations exhibited desirable properties. Various properties and formulations are shown in Table 5.

TABLE 5

| α Phase | | β Phase | | γ Phase | | γ-2 Phase | |
|---|---|---|---|---|---|---|---|
| 72% | WC | 8% | Co | 8% | TiC | 12% | TaC |
| 76% | WC | 8% | Co | 6% | TiC | 10% | TaC |
| 80% | WC | 10% | Co | 5% | TiC | 5% | TaC |

As will be understood by those skilled in the art, complex grades can have multiple elements/compounds to modify and formulate specific properties. In some embodiments, objects made from the above compositions had various transverse rupture strength (TRS), hardness, and density

In some embodiments, the entire article is made from the composition. In other embodiments, only a portion of the article is made from the composition. For example, the decorative portion of a pin can be made from the composition and the rest of the pin can be made from standard materials. Where the article is a finger ring, the composition can comprise the majority of the ring, except for an inlaid gemstone, or an inlay in an annular groove formed in the composition, e.g., as illustrated in relation to rings made from tungsten carbide in U.S. Pat. No. 7,076,972. Those rings have at least one depression that extends into, and at least substantially around the circumference of, an outer surface of the finger ring. In some embodiments, the depression in those rings is substantially filled with a precious metal.

In additional embodiments, the composition can comprise a minority of the article, for example as a portion of a sculpture primarily made of other materials, or as a contrasting band in a ring made primarily from another metal such as gold or silver.

In some embodiments, the article is a decorative or artistic item, for example, a sculpture, a portion of a picture frame, a paperweight, a portion of a piece of furniture (e.g., an inlay), or jewelry. Non-limiting examples of jewelry that can be made from the Ti-based composition are rings (e.g., finger rings, toe rings, nose rings), pendants, tags, dog tags, hairclips, chains, watchcases, pins, bracelets, anklets, necklaces, earrings and charms.

The item of jewelry comprising the composition can further comprise any other material used in jewelry affixed or integrated into the item. Examples include a precious metal (e.g., gold, silver, platinum) either as part of the composition or affixed to the item, a stone, a gemstone, a crystal, or any other material suitable for use in jewelry affixed to the item.

In particular embodiments, the item of jewelry is a finger ring or a watch casing. The ring or watch casing can be made entirely of the composition, or the ring or watch casing can further comprise other materials, for example an inlaid gemstone, or an inlay in an annular groove formed in the composition. In an embodiment, the jewelry article may include inlays, gems, gemstones, minerals, rocks, stones, wood, rubber, or other precious or semi precious materials or metals. Inlays may include metals, stones, gems, minerals, glass, wood, rubber, plastic or any other materials including but not limited to gold, silver, platimum, steel, titanium, cobalt chrome, stainless steel, aluminum, carbon fiber, texallium fibers, and kevlar fibers. The inlay may cover a whole or a part of the jewelry article and can be flush mounted or surface mounted using any known techniques.

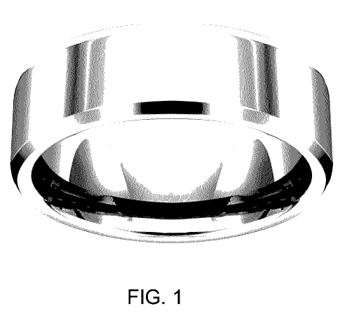

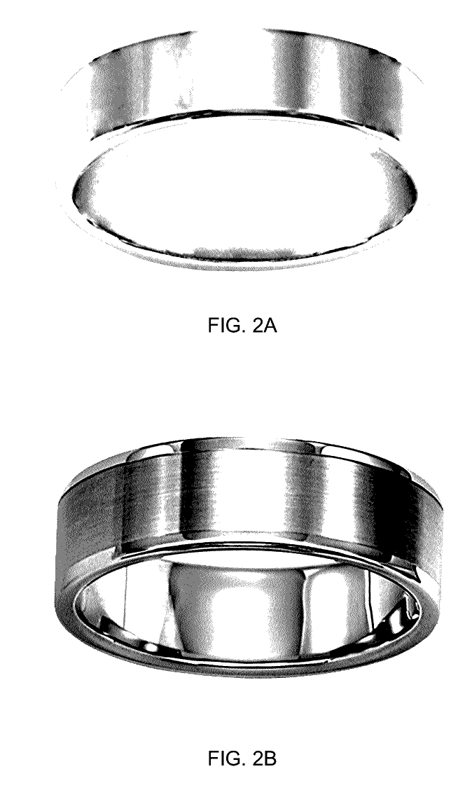

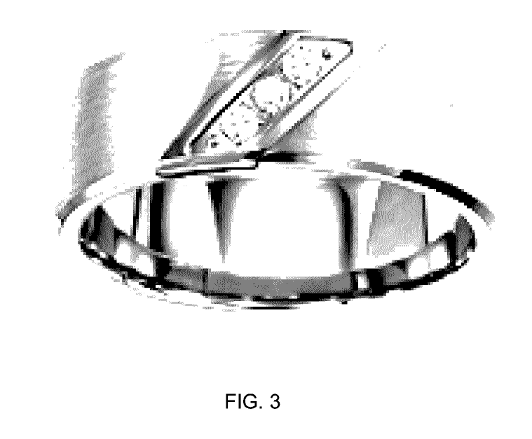

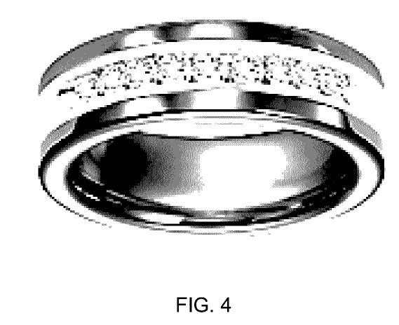

Illustrative examples of finger rings are provided in FIGS. 1-4. FIG. 1 shows a ring made from the Ti-based composition in accordance with an embodiment of the present disclosure. FIGS. 2A and 2B show examples of finger rings made from the Ti-based composition in accordance with an embodiment of the present disclosure. FIG. 3 shows an additional example of a finger ring made from the Ti-based composition in accordance with an embodiment of the present disclosure. This ring has diamonds set in a sterling silver annular groove inlay. FIG. 4 shows a further example of a finger ring made from the Ti-based composition. This ring has diamonds set in a precious metal insert.

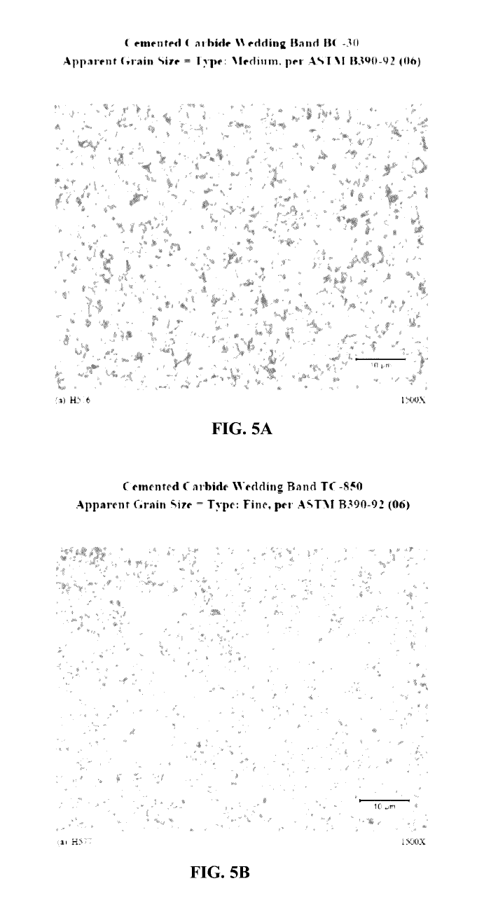

FIGS. 5A and 5B depict images of apparent grain size in cemented carbide jewelry articles and components of jewelry articles made in accordance with the present disclosure. As seen in FIG. 5A, a sample of BC-30 comprises medium size grains when measured utilizing ASTM390-92(06). Similarly, as seen in FIG. 5B, a sample of TC-850 comprises fine grains when measured utilizing ASTM390-92(06).

The articles, including jewelry articles and components of jewelry articles, provided herein can be made by any method known. In some embodiments, an ingot, bar, sheet or other form of the composition is provided, followed by cutting, shaping and polishing the ingot or bar to form a piece having a desired shape, then optionally polishing the piece with a finish polish.

In an embodiment, the article maybe manufactured by investment casting or other traditional industrial process based on and also called lost-wax casting. Investment or lost wax casting is described in US Patent Publication No. 2013/0287622 to Hoffman and U.S. Pat. No. 6,013,125 to Quraishi et al. entitled Investment of Powders and Method for Rapid Preparation of Investment Molds, both of which are incorporated herein in there entirety by reference.

In lost wax casting casts can be made of a wax model itself (the direct method); or of a wax copy of a model that need not be of wax (the indirect method). Wax casting may generally include producing a master pattern (model making) and then forming a mold, known as the master die. Wax patterns may be attached to a sprue or each other by means of a heated metal tool and then chased. Next, the ceramic mold, known as the investment, is produced by three repeating steps: coating, stuccoing, and hardening. The first step involves dipping the cluster into a slurry of fine refractory material and then letting any excess drain off, so a uniform surface is produced. In the second step, the cluster is stuccoed with a coarse ceramic particle, by dipping it into a fluidized bed, placing it in a rainfall-sander, or by applying by hand. Finally, the coating is allowed to harden. These steps are repeated until the investment is the required thickness. The investment is then allowed to completely dry. Drying can be enhanced by applying a vacuum or minimizing the environmental humidity. It is then turned upside-down and placed in a furnace or autoclave to melt out and/or vaporize the wax. The mold is then subjected to a burnout to remove any moisture and residual wax, and to sinter the mold.

The steps of the indirect process include model-making, where an artist or mold-maker creates an original model from wax, clay, or another material. Wax and oil-based clay are often preferred because these materials retain their softness. Next, a mold is made of the original model or sculpture. The rigid outer molds contain the softer inner mold, which is the exact negative of the original model. Inner molds are usually made of latex, polyurethane rubber or silicone, which is supported by the outer mold. The outer mold can be made from plaster, but can also be made of fiberglass or other materials. Most molds are made of at least two pieces, and a shim with keys is placed between the parts during construction so that the mold can be put back together accurately. If there are long, thin pieces extending out of the model, they are often cut off of the original and molded separately. Sometimes many molds are needed to recreate the original model, especially for large models.

Once the mold is finished, molten wax is poured into it and swished around until an even coating, usually about ⅛ inch (3 mm) thick, covers the inner surface of the mold. This is repeated until the desired thickness is reached. Another method is to fill the entire mold with molten wax and let it cool until a desired thickness has set on the surface of the mold. After this the rest of the wax is poured out again, the mold is turned upside down and the wax layer is left to cool and harden. With this method it is more difficult to control the overall thickness of the wax layer.

This hollow wax copy of the original model is removed from the mold. The model-maker may reuse the mold to make multiple copies, limited only by the durability of the mold. Each hollow wax copy is then “chased”: a heated metal tool is used to rub out the marks that show the parting line or flashing where the pieces of the mold came together. The wax is dressed to hide any imperfections. The wax now looks like the finished piece. Wax pieces that were molded separately can now be heated and attached; foundries often use registration marks to indicate exactly where they go. The wax copy is sprued with a treelike structure of wax that will eventually provide paths for the molten casting material to flow and for air to escape. The carefully planned spruing usually begins at the top with a wax “cup,” which is attached by wax cylinders to various points on the wax copy. The spruing does not have to be hollow, as it will be melted out later in the process. A sprued wax copy is dipped into a slurry of silica, then into a sand-like stucco, or dry crystalline silica of a controlled grain size. The slurry and grit combination is called ceramic shell mold material, although it is not literally made of ceramic. This shell is allowed to dry, and the process is repeated until at least a half-inch coating covers the entire piece. The bigger the piece, the thicker the shell needs to be. Only the inside of the cup is not coated, and the cup's flat top serves as the base upon which the piece stands during this process.

The ceramic shell-coated piece is placed cup-down in a kiln, whose heat hardens the silica coatings into a shell, and the wax melts and runs out. The melted wax can be recovered and reused, although it is often simply burned up. Now all that remains of the original artwork is the negative space formerly occupied by the wax, inside the hardened ceramic shell. The feeder, vent tubes and cup are also now hollow. The ceramic shell is allowed to cool, then is tested to see if water will flow freely through the feeder and vent tubes. Cracks or leaks can be patched with thick refractory paste. To test the thickness, holes can be drilled into the shell, then patched. The shell is reheated in the kiln to harden the patches and remove all traces of moisture, then placed cup-upwards into a tub filled with sand. Metal is melted in a crucible in a furnace, then poured carefully into the shell. The shell has to be hot because otherwise the temperature difference would shatter it. The filled shells are then allowed to cool.

The shell is hammered or sand-blasted away, releasing the rough casting. The sprues, which are also faithfully recreated in metal, are cut off, the material to be reused in another casting. Metal-chasing. Just as the wax copies were chased, the casting is worked until the telltale signs of the casting process are removed, so that the casting now looks like the original model. Pits left by air bubbles in the casting and the stubs of the spruing are filed down and polished. Prior to silica-based casting molds, these molds were made of a variety of other fire-proof materials, the most common being plaster based, with added grout, and clay based.

The cemented articles, including jewelry articles and components of jewelry articles, of the present disclosure may also be made utilizing metal Injection Molding (MIM). As is well known, the MIM process may involve steps that combine metal powders with wax and/or plastic binders to produce a “feedstock” mix that can be injected as a liquid or semiliquid into a hollow mold using plastic injection molding machines. The “green part” is cooled and de-molded in the plastic molding machine. Next, a portion of the binder material is removed using solvent, thermal furnaces, catalytic process, or a combination of methods. The resulting part, in a condition called “brown” stage, requires the metal to be condensed utilizing a sintering process. MIM parts may be sintered in a single step or may be pre-sintered in multiple steps. Metals and articles, including jewelry articles and components of jewelry articles, manufactured utilizing the MIM process are compatible with traditional metal conditioning treatments such as plating, passivating, annealing, carburizing, nitriding, and precipitation hardening.

The cemented articles, including jewelry articles and components of jewelry articles, of the present disclosure may also be formed utilizing green machining techniques. As is known in the art, green machining involves the shaping or machining of an article in an unfired state. Green machining of may be done whenever possible since the machining of the cemented articles, including jewelry articles and components of jewelry articles, after sintering is very costly. Green machining may utilize CNC machines, lathes, drilling equipment, cut-off saws, surface grinders, rotary grinders, as well as any other machines used to form an object. Machining may require the use of carbide and PCD tools and abrasive wheels.

A “blank” of the article can then be cut from the bar or sheet, for example using wire electric discharge machining (EDM). Any internal areas that need to be hollowed out of the blank (e.g., the center portion of a ring) can be removed, e.g., using a sink EDM. A CNC lathe can then be used to prepare the outer shape of the article, followed by polishing. At this point, any inlays, setting or engraving can be performed. Where the article is a ring or similar article that requires internal sizing, a CNC lathe, followed by an inner polish can be used at this point.

After the above shaping of the article, the article can be subjected to one or more heat treatment(s), followed by final polishing followed and any additional engraving desired, for example using a CNC lathe or CNC engraving.

The articles, including jewelry articles and components of jewelry articles, of the present disclosure may also be formed utilizing a sinter hot isostatic pressing (HIP) process. HIP may be used as part of a sintering (powder metallurgy) process for fabrication of metal matrix composites such as the articles, including jewelry articles and components of jewelry articles, of the present disclosure. The HIP process subjects a component to both elevated temperature and isostaic gas pressure in a high pressure containment vessel. The pressurizing gas most widely used typically an inert gas such as Argon, so that the material does not chemically react with the pressurized gas, During the process, a chamber is heated, causing the pressure inside the vessel to increase. Traditionally, the gas may be applied at pressures between 7,350 psi (50.7 MPa) and 45,000 psi (310 MPa), with 15,000 psi (100 MPa) being most common. When castings are treated with HIP, the simultaneous application of heat and pressure may eliminate internal voids and microporosity through a combination of plastic deformation, creep, and diffusion bonding.

Alternatively, articles, including jewelry articles and components of jewelry articles, having any of the compositions described herein can be formed by a powder metallurgy process, wherein the above-described constituent components are blended in powder form, then pressed or injected to form a blank. The constituents described herein may be provided in their elemental powdered form. Alternatively, the powders may themselves be combinations of different metals or constituent components. The blank may approximate the final shape or form of the article. This is often referred to as “near-net-shape.” The blank can then be consolidated by sintering. The result of the sintering is a dense object possessing the desired coloration, hardness, abrasion resistance and other features as described herein. One non-limiting example of a possible powder metallurgy based formation technique is Hot Isostatic Pressing (HIP).

An article, such as any of the jewelry articles and components of jewelry articles described herein, formed at least in part from cermet can be produced by any suitable technique that results in a dense object having the desired physical properties as well as the desired coloration. For example, suitable methods may comprise combining the constituent elements in powder form, pressing or injecting the powders to form a blank or near net-shape object, and sintering to consolidate the blank or object and provide a grey/dark grey/black appearance. Examples of specific techniques for pressing, injecting, molding and sintering to form a final article, such as an article of jewelry, have been previously described above in connection with powder metallurgical techniques.

These techniques can also be used to form articles, such as jewelry articles and components of jewelry articles, and are incorporated herein by reference. For example, the methods or techniques described in the United States Patent Application Publication No. US 2012-0304694 may be used, the content of which is incorporated herein by reference in its entirety for all purposes.

Articles formed according to the principles of the present disclosure, including jewelry articles and components of jewelry articles described herein, may have one or more advantageous properties and/or characteristics.

According to other embodiments of the present disclosure, articles, including jewelry articles and components of jewelry articles, can be formed which possess a favorable density property. More specifically, articles, including jewelry articles and components of jewelry articles, formed according to the principles of the present disclosure may possess density values of about 9.00 to about 15.00 g/cm³. In an embodiment, the density readings for BC-30 were 12.58 g/cm³ and for samples of TC-850 were 14.55 g/cm³. In additional embodiments, sample densities were measured, as shown in Table 6.

TABLE 6

| | |
|---|---|
| New densities | BC-30CR2 = 12.45 gm/cm³ |
| | BC-35CR2 = 12.14 gm/cm³ |
| Comparative | TC850 = 13.95 gm/cm³ |
| densities | CP-Titanium = 4.51 gm/cm³ |
| | 316 Steel = 7.99 gm/cm³ |
| | 10KW Gold = 11.07 gm/cm³ |

Additionally, densities for other samples included CP—Ti: 4.51 g/cm³; 316 steel: 7.99 g/cm³ and 10 k white gold: 11.07 g/cm³

According to certain embodiments, articles, including jewelry articles and components of jewelry articles, formed according to the principles of the present disclosure possess a Vickers hardness number (HV) of about 900HV to 1150HV. According to one specific and non-limiting embodiment, the material of the present disclosure has a hardness of about 1100HV. In an embodiment, a sample of BC-30 had a HV of about 800HV to about 1400HV. In another embodiment, sample of TC-850 had a HV of about 900HV-about 1400HV. In another embodiment, sample of TC-850 had a HV of about 1345HV.

According to certain embodiments, articles, including jewelry articles and components of jewelry articles, formed according to the principles of the present disclosure are significantly lighter than those formed from other materials. In an embodiment, several samples were formed for the same article made from TC850 vs. BC-30 (i.e., mostly TC as compared to TC in conjunction with chromium). As evidenced by these samples, as shown in Table 7, the BC-30 samples formed from TC in conjunction with chromium in accordance with the present disclosure weighed significantly less than the samples made from mostly TC.

TABLE 7

| | TC850 | BC-30 | Difference | % |
|---|---|---|---|---|
| Sample | Wgt. in gms. | Wgt. in gms | in gms. | difference |
| 1 | 11.36 | 9.83 | 1.52 | −13% |
| 2 | 11.27 | 9.92 | 1.35 | −12% |
| 3 | 8.21 | 7.32 | 0.89 | −11% |
| 4 | 11.83 | 9 | 2.83 | −24% |

According to further optional embodiments, an article formed according to the principles of the present disclosure possesses a cracking load of no more than about 1000 lbf.

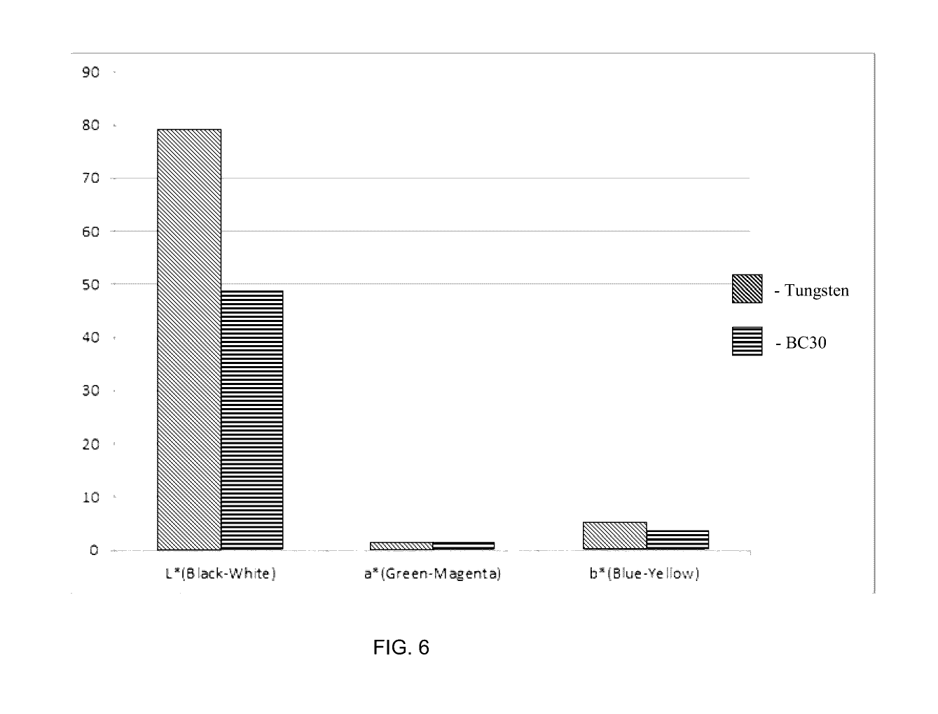

According to additional embodiments, an article formed according to the principles of the present disclosure possesses a coloration characterized by a range of L, a, and b values. More specifically, articles, including jewelry articles and components of jewelry articles, formed according to the principles of the present disclosure possess a “L*” value of about 40-80. According to further embodiments, the articles, including jewelry articles and components of jewelry articles, further possess an “a*” value of about 0-1.0. According to additional embodiments, the articles, including jewelry articles and components of jewelry articles, further possess a “b*” value of about 2.0-7.0. According to one illustrative, non-limiting example, an article formed according to the principles of the present disclosure possesses a coloration characterized as: L*=about 48.5, a*=about 0.77, and b*=about 3.7. In an embodiment, the following samples were created and analyzed using a Konica-Minolta CM-700 spectrometer. Measurements for a number of samples is shown in Tables 8-9, and FIG. 6.

TABLE 8

| | Data Name | L*(D65) | a*(D65) | b*(D65) |
|---|---|---|---|---|
| Target | Average Target BC-30 | 48.5 | 0.77 | 3.7 |
| Target | Average Target BC-30 | 79.12 | 0.82 | 5.02 |

TABLE 9

| | | Data Name | | | | | | | |
|---|---|---|---|---|---|---|---|---|---|
| | | L*(D65) | a*(D65) | b*(D65) | dL*(D65) | da*(D65) | db*(D65) | dE*ab(D65) | dE00(D65) |
| Target | Averaged Target BC-10 | 48.5 | 0.77 | 3.7 | — | — | — | — | — |
| 1 | BC-10#0001 | 47.75 | 0.71 | 3.27 | −0.75 | −0.05 | −0.42 | 0.86 | 0.83 |
| 2 | BC-10#0002 | 48.73 | 0.67 | 3.22 | 0.23 | −0.09 | −0.48 | 0.54 | 0.49 |
| 3 | BC-10#0003 | 51.6 | 0.84 | 3.85 | 3.1 | 0.07 | 0.15 | 3.1 | 3.1 |
| 4 | BC-10#0004 | 46.67 | 0.81 | 3.96 | −1.83 | 0.05 | 0.27 | 1.85 | 1.81 |
| 5 | BC-10#0005 | 47.52 | 0.8 | 4.21 | −0.97 | 0.03 | 0.51 | 1.1 | 1.06 |
| Target | Averaged Target TC850 | 79.12 | 0.82 | 5.02 | — | — | — | — | — |
| 1 | TC850#0001 | 78.15 | 0.75 | 4.88 | −0.97 | −0.07 | −0.14 | 0.99 | 0.7 |
| 2 | TC850#0002 | 78.37 | 0.89 | 5.22 | −0.75 | 0.07 | 0.21 | 0.78 | 0.56 |
| 3 | TC850#0003 | 77.6 | 0.86 | 5.51 | −1.52 | 0.03 | 0.49 | 1.6 | 1.14 |
| 4 | TC850#0004 | 80.55 | 0.75 | 4.59 | 1.42 | −0.07 | −0.42 | 1.49 | 1.05 |
| 5 | TC850#0005 | 80.86 | 0.86 | 4.92 | 1.73 | 0.04 | −0.1 | 1.73 | 1.2 |

FIG. 6 shows a graph depicting the color values for samples of BC-30 and Tungsten samples. As graphed, the color characteristics for BC-30 yield different results especially in the L* (Black-White) range when compared with objects containing high levels of tungsten, such as TC-850.

For base line comparisons, analysis of color readings of yellow with Yttrium, rose with Yttrium as well as straight cobalt-chrome and black Tungsten Carbide were performed. As is understood by those skilled in the art, the additional materials and additives generally impacts the optical characteristics of the object. The color characteristics of other samples are shown in Table 10.

TABLE 10

| | | Data Name | | | | | | | |
|---|---|---|---|---|---|---|---|---|---|
| | | L*(D65) | a*(D65) | b*(D65) | dL*(D65) | da*(D65) | db*(D65) | dE*ab(D65) | dE00(D65) |
| Target | Averaged Target BC-10 | 48.5 | 0.77 | 3.7 | — | — | — | — | — |
| 1 | BC-10#0001 | 47.75 | 0.71 | 3.27 | −0.75 | −0.05 | −0.42 | 0.86 | 0.83 |
| 2 | BC-10#0002 | 48.73 | 0.67 | 3.22 | 0.23 | −0.09 | −0.48 | 0.54 | 0.49 |
| 3 | BC-10#0003 | 51.6 | 0.84 | 3.85 | 3.1 | 0.07 | 0.15 | 3.1 | 3.1 |
| 4 | BC-10#0004 | 46.67 | 0.81 | 3.96 | −1.83 | 0.05 | 0.27 | 1.85 | 1.81 |
| 5 | BC-10#0005 | 47.52 | 0.8 | 4.21 | −0.97 | 0.03 | 0.51 | 1.1 | 1.06 |
| Target | Averaged Target TC850 | 79.12 | 0.82 | 5.02 | — | — | — | — | — |
| 1 | TC850#0001 | 78.15 | 0.75 | 4.88 | −0.97 | −0.07 | −0.14 | 0.99 | 0.7 |
| 2 | TC850#0002 | 78.37 | 0.89 | 5.22 | −0.75 | 0.07 | 0.21 | 0.78 | 0.56 |
| 3 | TC850#0003 | 77.6 | 0.86 | 5.51 | −1.52 | 0.03 | 0.49 | 1.6 | 1.14 |
| 4 | TC850#0004 | 80.55 | 0.75 | 4.59 | 1.42 | −0.07 | −0.42 | 1.49 | 1.05 |
| 5 | TC850#0005 | 80.86 | 0.86 | 4.92 | 1.73 | 0.04 | −0.1 | 1.73 | 1.2 |
| Target | Averaged Target Cobalt | 80.61 | 1.05 | 5.89 | — | — | — | — | — |
| 1 | Cobalt#0001 | 79.27 | 1.16 | 6.21 | −1.34 | 0.1 | 0.32 | 1.38 | 0.97 |
| 2 | Cobalt#0002 | 79.72 | 1.01 | 5.66 | −0.89 | −0.05 | −0.24 | 0.93 | 0.65 |
| 3 | Cobalt#0003 | 81.5 | 1.03 | 5.8 | 0.89 | −0.02 | −0.1 | 0.89 | 0.61 |
| 4 | Cobalt#0004 | 80.91 | 1.04 | 5.73 | 0.3 | −0.01 | −0.17 | 0.34 | 0.24 |
| 5 | Cobalt#0005 | 81.62 | 1.04 | 6.09 | 1 | −0.02 | 0.19 | 1.02 | 0.7 |
| Target | Averaged Target White | 88.25 | 0.75 | 5.03 | — | — | — | — | — |
| 1 | White#0001 | 85.67 | 0.82 | 4.75 | −2.57 | 0.07 | −0.28 | 2.59 | 1.68 |
| 2 | White#0002 | 88.25 | 0.81 | 5.29 | 0 | 0.06 | 0.25 | 0.26 | 0.22 |
| 3 | White#0003 | 89.62 | 0.73 | 4.96 | 1.38 | −0.02 | −0.07 | 1.38 | 0.87 |
| 4 | White#0004 | 89.87 | 0.69 | 4.96 | 1.62 | −0.06 | −0.07 | 1.63 | 1.03 |
| 5 | White#0005 | 87.7 | 0.71 | 5.2 | −0.54 | −0.04 | 0.17 | 0.57 | 0.38 |
| Target | Averaged Target Black | 29.37 | 0.25 | 1.69 | — | — | — | — | — |
| 1 | Black#0001 | 29.19 | 0.16 | 1.78 | −0.18 | −0.09 | 0.08 | 0.22 | 0.21 |
| 2 | Black#0002 | 28.39 | 0.24 | 0.65 | −0.98 | −0.01 | −1.04 | 1.43 | 1.24 |
| 3 | Black#0003 | 31.46 | 0.17 | 1.23 | 2.09 | −0.09 | −0.46 | 2.14 | 1.69 |
| 4 | Black#0004 | 29.13 | 0.41 | 2.89 | −0.24 | 0.16 | 1.2 | 1.24 | 1.12 |
| 5 | Black#0005 | 28.55 | 0.3 | 1.98 | −0.83 | 0.05 | 0.29 | 0.87 | 0.69 |
| Target | Averaged Target Yellow | 86.72 | 6.1 | 31.19 | — | — | — | — | — |
| 1 | Yellow#0001 | 86.58 | 6.28 | 31.65 | −0.14 | 0.18 | 0.46 | 0.51 | 0.23 |
| 2 | Yellow#0002 | 86.09 | 6.21 | 31.65 | −0.63 | 0.11 | 0.46 | 0.79 | 0.45 |
| 3 | Yellow#0003 | 86.27 | 5.9 | 29.54 | −0.45 | −0.2 | −1.65 | 1.72 | 0.76 |
| 4 | Yellow#0004 | 87.77 | 5.87 | 31.17 | 1.05 | −0.23 | −0.02 | 1.07 | 0.7 |
| 5 | Yellow#0005 | 86.87 | 6.24 | 31.96 | 0.15 | 0.14 | 0.77 | 0.8 | 0.34 |
| Target | Averaged Target Rose | 85.31 | 14.76 | 25.94 | — | — | — | — | — |
| 1 | Rose#0001 | 85.55 | 14.98 | 26.46 | 0.24 | 0.22 | 0.52 | 0.61 | 0.29 |
| 2 | Rose#0002 | 85.94 | 14.88 | 26.31 | 0.62 | 0.12 | 0.37 | 0.73 | 0.44 |
| 3 | Rose#0003 | 84.48 | 15.1 | 26.37 | −0.83 | 0.34 | 0.43 | 0.99 | 0.6 |
| 4 | Rose#0004 | 85.86 | 14.2 | 24.78 | 0.55 | −0.55 | −1.16 | 1.4 | 0.67 |
| 5 | Rose#0005 | 84.72 | 14.63 | 25.82 | −0.6 | −0.12 | −0.12 | 0.62 | 0.4 |

According to further alternative embodiments, the cemented carbide compositions according to the principles of the present disclosure possesses a favorable average grain sized property. For example, articles, including jewelry articles and components of jewelry articles, formulated according to the principles of the present disclosure may possess a average grain size of preferably about 2 to about 4 μm and more preferably about 1.4 μm to about 2.0 μm, when measured according to the previously mentioned ASTM E112-113 standard.

Articles, including jewelry articles and components of jewelry articles, formed from compositions of the present disclosure may further optionally possess favorable corrosion resistance values when measured according to the previously mentioned ASTM B-117 standard.

Articles, including jewelry articles and components of jewelry articles, formed according to additional alternative embodiments may further optionally possess favorable abrasion resistance properties of about when measured according to the previously mentioned ASTM D4060 standard.

As noted above with respect to the reported “cracking load” values, when compositions formed according to the principles of the present disclosure are utilized to produce articles of jewelry to be worn on the body, another important property is the ability of such articles formed thereby to be removed from the body in the event of an emergency. Thus, the compositions formulated according to the principles of the present disclosure have been designed to serve the need of a scratch resistant product, yet still have the ability to be removed by conventional techniques involving applying pressure to the article jewelry in a vice-like handheld or stationary tool in order to crack or shatter the article. The ability to remove a jewelry article according to such a process is not traditionally a property of an article comprising cobalt-chrome. The article breaks into a small number of pieces (3-5) as compared to TC which shatters into many tiny shards.

A similar consideration of the composition when utilized to produce finished articles in the form of jewelry is the ease in which the material can be machined or removed. Accordingly, the compositions formulated according to the principles of the present disclosure have been designed so as to facilitate machining and/or engraving through use of traditional diamond-based grinding and/or cutting tools, as well as electrical discharge machining (EDM).

### Examples

| Element | Sample #1 | Sample #2 |
|---|---|---|
| Silicon | 0.15 | 0.10 |
| Iron | 0.08 | — |
| Copper | — | — |
| Manganese | 0.02 | 0.02 |
| Nickel | 0.02 | 0.04 |
| Cobalt | 17.25 | 17.31 |
| Potassium | — | — |
| Chromium | 1.45 | 1.44 |
| Titanium | 0.56 | 0.56 |
| Tantalum | 0.02 | 0.02 |
| Carbon | 4.80 | 4.88 |
| Sulfur | 0.01 | 0.01 |
| Tungsten | Balance | Balance |
| Density (g/cc) | 12.67 | 13.13 |
| Max Load (lbs) | 1129 | 1016 |
| Displacement | 0.012 | 0.012 |
| @ Max Load | | |
| (in) | | |
| Vickers | 1056 | 1130 |
| Hardness | | |

Traditional cemented carbide blending and mixing process are described in U.S. Pat. No. 6,928,734 to West, entitled Jewelry Ring and Method of Manufacturing Same, as well as U.S. Pat. No. 3,515,540 to Meadows entitled Mixed Cobalt/Tungsten Carbide Powders, both of which are incorporated here in there entirety by reference.

In other embodiments, as shown in Tables 11-16, various objects and samples were constructed using traditional press and sinter processes and various amounts of cobalt with chromium additions as well as some small quantities of dopants such as carbide, nitride, boride.

TABLE 11

| | W | Co | Ni | Cr | Other | |
|---|---|---|---|---|---|---|
| | wt % | wt % | wt % | wt % | wt % | Material |
| Embodiment-1 | 62 | 35 | 0 | 2 | 1 | TaC |
| Embodiment-2 | 62 | 35 | 0 | 2 | 1 | NbC |
| Embodiment-3 | 62 | 35 | 0 | 2 | 1 | MoC |
| Embodiment-4 | 62 | 35 | 0 | 2 | 1 | TiC |
| Embodiment-5 | 62 | 35 | 0 | 2 | 1 | VC |
| Embodiment-6 | 62 | 35 | 0 | 2 | 1 | ZrC |
| Embodiment-7 | 62 | 35 | 0 | 2 | 1 | Hf |
| Embodiment-8 | 62 | 35 | 0 | 2 | 1 | Re |
| Embodiment-9 | 62 | 35 | 0 | 2 | 1 | Ru |
| Embodiment-10 | 62 | 35 | 0 | 2 | 1 | Os |
| Embodiment-11 | 62 | 35 | 0 | 2 | 1 | Ir |
| Embodiment-12 | 62 | 35 | 0 | 2 | 1 | Pt |

TABLE 12

| | W | Co | Ni | Cr | Other | |
|---|---|---|---|---|---|---|
| | wt % | wt % | wt % | wt % | wt % | Material |
| Embodiment-1 | 67 | 30 | 0 | 2 | 1 | TaC |
| Embodiment-2 | 67 | 30 | 0 | 2 | 1 | NbC |
| Embodiment-3 | 67 | 30 | 0 | 2 | 1 | MoC |
| Embodiment-4 | 67 | 30 | 0 | 2 | 1 | TiC |
| Embodiment-5 | 67 | 30 | 0 | 2 | 1 | VC |
| Embodiment-6 | 67 | 30 | 0 | 2 | 1 | ZrC |
| Embodiment-7 | 67 | 30 | 0 | 2 | 1 | Hf |
| Embodiment-8 | 67 | 30 | 0 | 2 | 1 | Re |
| Embodiment-9 | 67 | 30 | 0 | 2 | 1 | Ru |
| Embodiment-10 | 67 | 30 | 0 | 2 | 1 | Os |
| Embodiment-11 | 67 | 30 | 0 | 2 | 1 | Ir |
| Embodiment-12 | 67 | 30 | 0 | 2 | 1 | Pt |

TABLE 13

| | W | Co | Ni | Cr | Other | |
|---|---|---|---|---|---|---|
| | wt % | wt % | wt % | wt % | wt % | Material |
| Embodiment-1 | 72 | 25 | 0 | 2 | 1 | TaC |
| Embodiment-2 | 72 | 25 | 0 | 2 | 1 | NbC |
| Embodiment-3 | 72 | 25 | 0 | 2 | 1 | MoC |
| Embodiment-4 | 72 | 25 | 0 | 2 | 1 | TiC |
| Embodiment-5 | 72 | 25 | 0 | 2 | 1 | VC |
| Embodiment-6 | 72 | 25 | 0 | 2 | 1 | ZrC |
| Embodiment-7 | 72 | 25 | 0 | 2 | 1 | Hf |
| Embodiment-8 | 72 | 25 | 0 | 2 | 1 | Re |
| Embodiment-9 | 72 | 25 | 0 | 2 | 1 | Ru |
| Embodiment-10 | 72 | 25 | 0 | 2 | 1 | Os |
| Embodiment-11 | 72 | 25 | 0 | 2 | 1 | Ir |
| Embodiment-12 | 72 | 25 | 0 | 2 | 1 | Pt |

TABLE 14

| | W | Co | Ni | Cr | Other | |
|---|---|---|---|---|---|---|
| | wt % | wt % | wt % | wt % | wt % | Material |
| Embodiment-1 | 77 | 20 | 0 | 2 | 1 | TaC |
| Embodiment-2 | 77 | 20 | 0 | 2 | 1 | NbC |
| Embodiment-3 | 77 | 20 | 0 | 2 | 1 | MoC |
| Embodiment-4 | 77 | 20 | 0 | 2 | 1 | TiC |
| Embodiment-5 | 77 | 20 | 0 | 2 | 1 | VC |
| Embodiment-6 | 77 | 20 | 0 | 2 | 1 | ZrC |
| Embodiment-7 | 77 | 20 | 0 | 2 | 1 | Hf |
| Embodiment-8 | 77 | 20 | 0 | 2 | 1 | Re |
| Embodiment-9 | 77 | 20 | 0 | 2 | 1 | Ru |
| Embodiment-10 | 77 | 20 | 0 | 2 | 1 | Os |
| Embodiment-11 | 77 | 20 | 0 | 2 | 1 | Ir |
| Embodiment-12 | 77 | 20 | 0 | 2 | 1 | Pt |

TABLE 15

| | W | Co | Ni | Cr | Other | |
|---|---|---|---|---|---|---|
| | wt % | wt % | wt % | wt % | wt % | Material |
| Embodiment-1 | 82 | 15 | 0 | 2 | 1 | TaC |
| Embodiment-2 | 82 | 15 | 0 | 2 | 1 | NbC |
| Embodiment-3 | 82 | 15 | 0 | 2 | 1 | MoC |
| Embodiment-4 | 82 | 15 | 0 | 2 | 1 | TiC |
| Embodiment-5 | 82 | 15 | 0 | 2 | 1 | VC |
| Embodiment-6 | 82 | 15 | 0 | 2 | 1 | ZrC |
| Embodiment-7 | 82 | 15 | 0 | 2 | 1 | Hf |
| Embodiment-8 | 82 | 15 | 0 | 2 | 1 | Re |
| Embodiment-9 | 82 | 15 | 0 | 2 | 1 | Ru |
| Embodiment-10 | 82 | 15 | 0 | 2 | 1 | Os |
| Embodiment-11 | 82 | 15 | 0 | 2 | 1 | Ir |
| Embodiment-12 | 82 | 15 | 0 | 2 | 1 | Pt |

TABLE 16

| | W | Co | Ni | Cr | Other | |
|---|---|---|---|---|---|---|
| | wt % | wt % | wt % | wt % | wt % | Material |
| Embodiment-1 | 87 | 10 | 0 | 2 | 1 | TaC |
| Embodiment-2 | 87 | 10 | 0 | 2 | 1 | NbC |
| Embodiment-3 | 87 | 10 | 0 | 2 | 1 | MoC |
| Embodiment-4 | 87 | 10 | 0 | 2 | 1 | TiC |
| Embodiment-5 | 87 | 10 | 0 | 2 | 1 | VC |
| Embodiment-6 | 87 | 10 | 0 | 2 | 1 | ZrC |
| Embodiment-7 | 87 | 10 | 0 | 2 | 1 | Hf |
| Embodiment-8 | 87 | 10 | 0 | 2 | 1 | Re |
| Embodiment-9 | 87 | 10 | 0 | 2 | 1 | Ru |
| Embodiment-10 | 87 | 10 | 0 | 2 | 1 | Os |
| Embodiment-11 | 87 | 10 | 0 | 2 | 1 | Ir |
| Embodiment-12 | 87 | 10 | 0 | 2 | 1 | Pt |

In the press and sinter process used in the above embodiments, once a suitable press and mold have been prepared, the first step in making the object is to mix a predetermined combination of powdered metal or ceramic constituents to develop a sinterable metallic or ceramic powder. Once properly measured and disposed within the mold cavity, the powder is compressed by the mold to develop an oversized “green” ring blank that, although somewhat fragile, is stable enough to allow certain processing to be accomplished prior to sintering. For example, mold lines may be trimmed and smoothed, surfaces may be sanded or textured, facets may be smoothed, etc. But once properly prepared, the next step is to load the blank at room temperature into a non-atmospheric sintering chamber and raise the temperature thereof to controlled temperatures, typically varying between about 1000° C. to about 2000° C. and then slowly cooling back to atmospheric temperature. Once cooled, the hardened object blank configuration can be ground and polished to provide the hard metal or ceramic ring component.

TABLE 17

| | | | | | | | | | | | | Metallic |
|---|---|---|---|---|---|---|---|---|---|---|---|---|
| | α Phase | | β Phase | | β-2 Phase | | γ Phase | | γ-2 Phase | | | binder % |
| 1 | 68% | WC | | Co | 30% | Ni | 2% | Cr2 | | | 100% | 32% |
| 2 | 73% | WC | | Co | 25% | Ni | 2% | Cr2 | | | 100% | 27% |
| 3 | 78% | WC | | Co | 20% | Ni | 2% | Cr2 | | | 100% | 22% |
| 4 | 71% | WC | | Co | 25% | Ni | 2% | Cr2 | 2% | TaNC | 100% | 29% |
| 5 | 76% | WC | | Co | 20% | Ni | 2% | Cr2 | 2% | TaNC | 100% | 24% |
| 6 | 73% | WC | 20% | Co | 5% | Ni | 2% | Cr2 | | | 100% | 27% |
| 7 | 78% | WC | 15% | Co | 5% | Ni | 2% | Cr2 | | | 100% | 22% |
| 8 | 78% | WC | 10% | Co | 10% | Ni | 2% | Cr2 | | | 100% | 22% |
| 9 | 76% | WC | 15% | Co | 5% | Ni | 2% | Cr2 | 2% | TaNC | 100% | 24% |
| 10 | 76% | WC | 10% | Co | 10% | Ni | 2% | Cr2 | 2% | TaNC | 100% | 24% |
| | | | | | | | | | | | | 25% |

In an embodiment, nickel is used instead of, or in combination with, cobalt. As illustrated in Table 17, nickel in about 20 to about 30 wt. % may be used to replace cobalt in an embodiment. In another embodiment, cobalt-nickel blends in the ratios of about 5 to about 10 wt. % nickel and about 10 to about 20 wt. % cobalt may be used.

In some embodiments, the present disclosure relates to a method for producing a coated jewelry article or a coated component of a jewelry article, comprising: providing a jewelry article or a component of a jewelry article; and subjecting the jewelry article or the component of a jewelry article to a layering process to obtain a coated jewelry article or component of a jewelry article comprising a coating, wherein the jewelry article or component of a jewelry article and the coating form a surface that is resistant to deformation and wear and substantially retains the color of the coating material. In further embodiments, the first coated jewelry article or component of the jewelry article comprises cobalt, or cobalt and a material as described herein, or alloys of each of the foregoing and any combinations thereof. In additional embodiments, the coating comprises at least one of tungsten carbide, cobalt, tungsten, titanium, titanium carbide, zirconium, tantalum, rhodium, gold, silver, platinum, palladium, iridium, iron, stainless steel, 316 stainless steel, cobalt chrome, cobalt chromium, nickel, nitinol, aluminum, aluminum carbide, vanadium, ruthenium, copper, tungsten copper, zinc, tin, German silver, niobium, molybdenum, rhenium, hafnium, alloys of each of the foregoing and any combinations thereof.

In some embodiments, the coating comprises cobalt-chromium. In further embodiments, the jewelry article or component of the jewelry article is a ring, ornamental ring, engagement ring, toe ring, watch, bracelet, necklace, pendant, charm, armlet, brocade, pin, clip, hairclip, fob, ornamental piercing, earring, nose ring, dog tag, amulet, bangle bracelet, cuff bracelet, link bracelet, cuff link, key chain, money clip, cell phone charm, signet ring, class ring, friendship ring or purity ring or a component any of the foregoing. In still further embodiments, the coating comprises at least one of titanium nitride (TiN), titanium(2) nitride (Ti.sub.2N), titanium carbo-nitride (TiCN), titanium-aluminum nitride (TiAlN), titanium-aluminum carbo-nitride (TiAlCN), chromium nitride (CrN), zirconium nitride (ZrN), chromium-titanium nitride (CrTiN), aluminum-titanium nitride (AlTiN), aluminum-titanium-chromium nitride (AlTiCrN), titanium-zirconium (TiZi), titanium-niobium-zirconium (TiNiZi), tungsten nitride (WN), titanium diboride (TiB.sub.2), tungsten carbide, cobalt, tungsten, titanium, titanium carbide, zirconium, tantalum, rhodium, gold, silver, platinum, palladium, iridium, iron, stainless steel, cobalt chrome, cobalt chromium, nickel, nitinol, aluminum, aluminum carbide, vanadium, ruthenium, copper, brass, bronze, tungsten copper, zinc, tin, German silver, niobium, molybdenum, hafnium, rhenium, chromium, a steel alloy, gold nitride, silver nitride, aluminum nitride, vanadium nitride, tantalum nitride, chromium carbide, zirconium carbide, tantalum carbide, cobalt chrome molybdenum and alloys of each of the foregoing and any combinations thereof. In additional embodiments, the coating comprises at least one of cobalt-chromium, cobalt, stainless steel, nickel, chromium and zirconium. In some embodiments, the coating is selected from the group consisting of a metal, a metal compound, a material having metallic properties, a metallic compound, a metal alloy, a metal carbide, a metal nitride and a metal boride.

In some embodiments, the coating exhibits electrical conductivity. In further embodiments, the coating is deposited onto the substrate using electroplating, physical vapor deposition (PVD) or chemical vapor deposition (CVD). In still further embodiments, the coating alters the luster of the jewelry article. In additional embodiments, the luster is selected from color change, adamantine, dull, greasy, metallic, pearly, resinous, silky, submetallic, vitreous, waxy, asterism, aventurescence, chatoyancy, and schiller. In additional embodiments, the jewelry article or component of the jewelry article is capable of being manipulated prior to the layering process. In some embodiments, the manipulation is performed using at least one of a CNC machine, a laser, photo lithography, a water jet, a lathe, a tumbler, a drill, a saw, a file, power tools and hand tools.

In some embodiments, the present invention relates to a jewelry article or component of a jewelry article having a metal or metallic coating, comprising: a jewelry article or a component of a jewelry article; and a coating comprising a metal, a metal compound, a material having metallic properties or a compound having metallic properties, wherein the coating is coupled to the jewelry article or component of the jewelry article, and wherein the jewelry article or component of the jewelry article and the coating form a surface that is resistant to deformation and wear and substantially retains the color of the coating material. In further embodiments, the jewelry article or component of the jewelry article comprises cobalt and one or more of titanium nitride (TiN), titanium(2) nitride (Ti.sub.2N), titanium carbo-nitride (TiCN), titanium-aluminum nitride (TiAlN), titanium-aluminum carbo-nitride (TiAlCN), chromium nitride (CrN), zirconium nitride (ZrN), chromium-titanium nitride (CrTiN), aluminum-titanium nitride (AlTiN), aluminum-titanium-chromium nitride (AlTiCrN), titanium-zirconium (TiZi), titanium-niobium-zirconium (TiNiZi), tungsten nitride (WN), titanium diboride (TiB.sub.2), tungsten carbide, chromium, or one of the other materials described herein, and alloys of each of the foregoing and any combinations thereof.

In some embodiments, the coated jewelry article or component of the jewelry article comprises cobalt and tungsten carbide. In further embodiments, the coating exhibits electrical conductivity. In still further embodiments, the coating is deposited onto the jewelry article or component of the jewelry article using electroplating, physical vapor deposition (PVD) or chemical vapor deposition (CVD). In additional embodiments, the coating comprises at least one of titanium nitride (TiN), titanium(2) nitride (Ti.sub.2N), titanium carbo-nitride (TiCN), titanium-aluminum nitride (TiAlN), titanium-aluminum carbo-nitride (TiAlCN), chromium nitride (CrN), zirconium nitride (ZrN), chromium-titanium nitride (CrTiN), aluminum-titanium nitride (AlTiN), aluminum-titanium-chromium nitride (AlTiCrN), titanium-zirconium (TiZi), titanium-niobium-zirconium (TiNiZi), tungsten nitride (WN), titanium diboride (TiB.sub.2), tungsten carbide, cobalt, tungsten, titanium, titanium carbide, zirconium, tantalum, rhodium, gold, silver, platinum, palladium, iridium, iron, stainless steel, cobalt chrome, cobalt chromium, nickel, nitinol, aluminum, aluminum carbide, vanadium, ruthenium, copper, brass, bronze, tungsten copper, zinc, tin, German silver, niobium, molybdenum, hafnium, rhenium, chromium, a steel alloy, gold nitride, silver nitride, aluminum nitride, vanadium nitride, tantalum nitride, chromium carbide, zirconium carbide, tantalum carbide, cobalt chrome molybdenum and alloys of each of the foregoing and any combinations thereof. In some embodiments, the coating comprises cobalt-chromium. In additional embodiments, the coating alters the luster of the metallic substance. In some embodiments, the luster is selected from color change, adamantine, dull, greasy, metallic, pearly, resinous, silky, submetallic, vitreous, waxy, asterism, aventurescence, chatoyancy, and schiller.

In some embodiments, the coating is selected from the group consisting of a metal, a metal alloy, a material having metallic properties, a metallic compound, a metal carbide, a metal nitride and a metal boride. In further embodiments, the jewelry article or component of the jewelry article is a ring, ornamental ring, engagement ring, toe ring, watch, bracelet, necklace, pendant, charm, armlet, brocade, pin, clip, hairclip, fob, ornamental piercing, earring, nose ring, dog tag, amulet, bangle bracelet, cuff bracelet, link bracelet, cuff link, key chain, money clip, cell phone charm, signet ring, class ring, friendship ring or purity ring or a component any of the foregoing. In still further embodiments, the coating comprises at least one of titanium nitride (TiN), titanium(2) nitride (Ti.sub.2N), titanium carbo-nitride (TiCN), titanium-aluminum nitride (TiAlN), titanium-aluminum carbo-nitride (TiAlCN), chromium nitride (CrN), zirconium nitride (ZrN), chromium-titanium nitride (CrTiN), aluminum-titanium nitride (AlTiN), aluminum-titanium-chromium nitride (AlTiCrN), titanium-zirconium (TiZi), titanium-niobium-zirconium (TiNiZi), tungsten nitride (WN), titanium diboride (TiB.sub.2), tungsten carbide, cobalt, tungsten, titanium, titanium carbide, zirconium, tantalum, rhodium, gold, silver, platinum, palladium, iridium, iron, stainless steel, cobalt chrome, cobalt chromium, nickel, nitinol, aluminum, aluminum carbide, vanadium, ruthenium, copper, brass, bronze, tungsten copper, zinc, tin, German silver, niobium, molybdenum, hafnium, rhenium, chromium, a steel alloy, gold nitride, silver nitride, aluminum nitride, vanadium nitride, tantalum nitride, chromium carbide, zirconium carbide, tantalum carbide, cobalt chrome molybdenum and alloys of each of the foregoing and any combinations thereof. In additional embodiments, the coating comprises at least one of cobalt-chromium, cobalt, stainless steel, nickel, chromium and zirconium.

In some embodiments, the present invention relates to a method for producing a jewelry article or a coated component of a jewelry article, comprising: (a) providing a jewelry article or a coated component of a jewelry article; (b) subjecting the jewelry article or coated component of the jewelry article to a first layering process to obtain a first coated jewelry article or coated component of a jewelry article comprising a first coating; and (c) subjecting the first coated jewelry article or coated component of the jewelry article to a second layering process to obtain a second coated jewelry article or coated component of a jewelry article comprising a second coating. In further embodiments, the jewelry article or coated component of the jewelry article comprises cobalt and at least one of tungsten carbide, or at least one of the other materials described herein and combinations and alloys of each of the foregoing. In additional embodiments, the first coating comprises cobalt and at least one of a metal, a material having metallic properties, a metal compound, a metallic compound, a metal alloy, a metal carbide and a metal boride.

In some embodiments, the jewelry article is a ring, ornamental ring, engagement ring, toe ring, watch, watchcase, watchband, bracelet, necklace, pendant, charm, armlet, brocade, pin, clip, hairclip, fob, ornamental piercing, earring, nose ring, dog tag, amulet, bangle bracelet, cuff bracelet, link bracelet, cuff link, key chain, money clip, cell phone charm, signet ring, class ring, friendship ring or purity ring or a component thereof. In further embodiments, the first coating comprises at least one of titanium diboride (TiB.sub.2), tungsten carbide, cobalt, tungsten, titanium, titanium carbide, zirconium, tantalum, rhodium, gold, silver, platinum, palladium, iridium, iron, stainless steel, cobalt chrome, cobalt chromium, nickel, nitinol, aluminum, aluminum carbide, vanadium, ruthenium, copper, brass, bronze, zinc, tin, German silver, niobium, molybdenum, hafnium, rhenium, chromium, a steel alloy, chromium carbide, zirconium carbide, tantalum carbide, cobalt chrome molybdenum and combinations and alloys of each of the foregoing. In further embodiments, the first coating is chromium. In still further embodiments, the first coating exhibits electrical conductivity. In additional embodiments, the first coating is deposited onto the substrate using vapor deposition, physical vapor deposition (PVD) or chemical vapor deposition (CVD).

In some embodiments, the second coating comprises at least one of titanium nitride (TiN), titanium(2) nitride (Ti.sub.2N), titanium carbo-nitride (TiCN), titanium-aluminum nitride (TiAlN), titanium-aluminum carbo-nitride (TiAlCN), chromium nitride (CrN), zirconium nitride (ZrN), chromium-titanium nitride (CrTiN), aluminum-titanium nitride (AlTiN), aluminum-titanium-chromium nitride (AlTiCrN), tungsten nitride (WN), titanium diboride (TiB.sub.2), tungsten carbide, cobalt, tungsten, titanium, titanium carbide, zirconium, tantalum, rhodium, gold, silver, platinum, palladium, iridium, iron, stainless steel, cobalt chrome, cobalt chromium, nickel, nitinol, aluminum, aluminum carbide, vanadium, ruthenium, copper, brass, bronze, tungsten copper, zinc, tin, German silver, niobium, molybdenum, hafnium, rhenium, chromium, a steel alloy, gold nitride, silver nitride, aluminum nitride, vanadium nitride, tantalum nitride, chromium carbide, zirconium carbide, tantalum carbide, cobalt chrome molybdenum and combinations and alloys of each of the foregoing. In further embodiments, the second coating alters the luster of the jewelry article. In still further embodiments, the luster is selected from color change, adamantine, dull, greasy, metallic, pearly, resinous, silky, submetallic, vitreous, waxy, asterism, aventurescence, chatoyancy, and schiller. In additional embodiments, the second coating exhibits electrical conductivity. In some embodiments, the second coating is deposited onto the substrate using electroplating, physical vapor deposition (PVD) or chemical vapor deposition (CVD). In further embodiments, the substrate is capable of being manipulated prior to the first layering process. In still further embodiments, the manipulation is performed using at least one of a CNC machine, a laser, photo lithography, a water jet, a lathe, a tumbler, a drill, a saw, a file, a tool, power tools and hand tools.

In some embodiments, the present invention relates to a coated jewelry item or a coated component of a jewelry item having a plurality of metal or metallic layers, comprising: a jewelry item or a component of a jewelry item; a first coating comprising a metal, a metal compound, a material having metallic properties or a compound having metallic properties, wherein the first coating is coupled to the jewelry item or the component of the jewelry item; and a second coating comprising a metal, a metal compound, a material having metallic properties or a compound having metallic properties, wherein the second coating is coupled to the first coating, and wherein the jewelry item or the component of the jewelry item, the first coating and the second coating form a surface that is resistant to deformation and wear. In further embodiments, the jewelry item or the component of the jewelry item, the first coating and the second coating form a surface that substantially retains the color of the second coating. In further embodiments, the jewelry item or the component of the jewelry item, comprises cobalt and at least one of tungsten carbide, chromium, or one of the other materials described herein and combinations and alloys of each of the foregoing. In additional embodiments, the first coating comprises at least one of a metal, a material having metallic properties, a metal compound, a metallic compound, a metal alloy, a metal carbide and a metal boride. In some embodiments, the first coating exhibits electrical conductivity.

In some embodiments, the first coating is deposited onto the jewelry item or the component of the jewelry item, using vapor deposition, physical vapor deposition (PVD) or chemical vapor deposition (CVD). In further embodiments, the first coating comprises at least one of titanium diboride (TiB.sub.2), tungsten carbide, cobalt, tungsten, titanium, titanium carbide, zirconium, tantalum, rhodium, gold, silver, platinum, palladium, iridium, iron, stainless steel, cobalt chrome, cobalt chromium, nickel, nitinol, aluminum, aluminum carbide, vanadium, ruthenium, copper, brass, bronze, zinc, tin, German silver, niobium, molybdenum, hafnium, rhenium, chromium, a steel alloy, chromium carbide, zirconium carbide, tantalum carbide, cobalt chrome molybdenum and combinations and alloys of each of the foregoing. In still further embodiments, the second coating comprises at least one of titanium nitride (TiN), titanium(2) nitride (Ti.sub.2N), titanium carbo-nitride (TiCN), titanium-aluminum nitride (TiAlN), titanium-aluminum carbo-nitride (TiAlCN), chromium nitride (CrN), zirconium nitride (ZrN), chromium-titanium nitride (CrTiN), aluminum-titanium nitride (AlTiN), aluminum-titanium-chromium nitride (AlTiCrN), tungsten nitride (WN), titanium diboride (TiB.sub.2), tungsten carbide, cobalt, tungsten, titanium, titanium carbide, zirconium, tantalum, rhodium, gold, silver, platinum, palladium, iridium, iron, stainless steel, cobalt chrome, cobalt chromium, nickel, nitinol, aluminum, aluminum carbide, vanadium, ruthenium, copper, brass, bronze, tungsten copper, zinc, tin, German silver, niobium, molybdenum, hafnium, rhenium, chromium, a steel alloy, gold nitride, silver nitride, aluminum nitride, vanadium nitride, tantalum nitride, chromium carbide, zirconium carbide, tantalum carbide, cobalt chrome molybdenum and combinations and alloys of each of the foregoing. In additional embodiments, the second coating alters the luster of the metallic substance. In some embodiments, the luster is selected from color change, adamantine, dull, greasy, metallic, pearly, resinous, silky, submetallic, vitreous, waxy, asterism, aventurescence, chatoyancy, and schiller. In further embodiments, the second coating exhibits electrical conductivity. In still further embodiments, the second coating is deposited onto the substrate using electroplating, physical vapor deposition (PVD) or chemical vapor deposition (CVD). In additional embodiments, the first coating is selected from the group consisting of a metal, a material having metallic properties, a metal compound, a metallic compound, a metal alloy, metal carbide and metal boride. In some embodiments, the second coating is selected from the group consisting of a metal, a material having metallic properties, a metal compound, a metallic compound, a metal alloy, metal carbide and metal boride. In further embodiments, the second coating comprises at least one of gold, silver, platinum, palladium, rhodium, ruthenium and an alloy of any of the foregoing. In still further embodiments, the second coating is a galvanic coating.

In some embodiments, the present invention further comprises washing the coated jewelry article or the coated component of the jewelry article. In further embodiments, the coated jewelry article, coated component of the jewelry article or coated jewelry item exhibits a non-gray color or luster. In other embodiments, the coated jewelry article, coated component of the jewelry article or coated jewelry item substantially retain the color of the second coating. In still further embodiments, the jewelry article, component of the jewelry article or jewelry item comprises cobalt and at least one of tungsten carbide, chrome, chromium, cobalt chrome or cobalt chromium. In additional embodiments, the coated jewelry article, coated component of the jewelry article or coated jewelry item comprises at least one layer of tungsten carbide, chrome, chromium, cobalt chrome or cobalt chromium. In some embodiments, the coated jewelry article, coated component of the jewelry article or coated jewelry item comprises at least one layer of steel, 316 stainless steel, nickel, nitinol, zirconium, cobalt, chrome, chromium, titanium-zirconium (TiZi), titanium-niobium-zirconium (TiNiZi) and an alloy of any of the foregoing. In further embodiments, the present invention relates to a method for making a jewelry ring comprising a substrate, a first coating of a metal, a material having metallic properties, a metal compound, a metallic compound, a metal alloy, metal carbide and metal boride, and an external metal or metallic coating, the method comprising cutting, pressing, molding, casting, striking, extruding, sintering and/or shaping the substrate into a ring shape; depositing the first coating onto the substrate; and depositing the external metal or metallic coating onto the first coating.

A method for making a jewelry ring comprising a substrate, a first coating of a metal, a material having metallic properties, a metal compound, a metallic compound, a metal alloy and a metal carbide, and an external metallic coating is additionally provided. The method comprises cutting, pressing, molding, casting, striking, extruding, sintering and/or shaping the substrate into a ring shape; depositing the first coating onto the substrate; and depositing the external metallic coating onto the first coating.

Other embodiments within the scope of the claims herein will be apparent to one skilled in the art from consideration of the specification or practice of the disclosure as disclosed herein. It is intended that the specification be considered exemplary only, with the scope and spirit being indicated by the claims.

In view of the above, it will be seen that the several advantages are achieved and other advantages attained. As various changes could be made in the above methods and compositions without departing from the scope of the disclosure, it is intended that all matter contained in the above description shall be interpreted as illustrative and not in a limiting sense.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

Any numbers expressing quantities of ingredients, constituents, reaction conditions, and so forth used in the application are to be understood as being modified in all instances by the term “about”. Notwithstanding that the numerical ranges and parameters setting forth, the broad scope of the subject matter presented herein are approximations, the numerical values set forth are indicated as precisely as possible. None of the features recited herein should be interpreted as invoking 35 U.S.C. §112, 6, unless the term “means” is explicitly used.

1. A jewelry article formed from a cemented carbide composition, the composition comprising about 8 to about 35 wt. % Co, and about 0.1 to about 3.5 wt. % Cr,
wherein the jewelry article is formed utilizing a hot isostatic pressing (HIP) process or sintering process.

2. The jewelry article of claim 1, wherein the composition comprises about 8 to about 10 wt. % Co, and about 0.1 to about 1.0 wt. % Cr.

3. The jewelry article of claim 1, wherein the composition comprises about 10 to about 15 wt. % Co, and about 1.0 to about 1.5 wt. % Cr.

4. The jewelry article of claim 1, wherein the composition comprises about 15 to about 20 wt. % Co, and about 1.5 to about 2.0 wt. % Cr.

5. The jewelry article of claim 1, wherein the composition comprises about 20 to about 25 wt. % Co, and about 2.0 wt. % Cr.

6. The jewelry article of claim 1, wherein the composition comprises about 25 to about 30 wt. % Co, and about 2.0 wt. % Cr.

7. The jewelry article of claim 1, wherein the composition comprises about 30 to about 35 wt. % Co, and about 2.0 wt. % Cr.

8. The jewelry article of claim 1, wherein the composition comprises about 25 to about 35 wt. % Co, and about 2.0 wt. % Cr.

9. The jewelry article of claim 1, wherein the composition comprises about 10 wt. % Co, and about 1.0 wt. % Cr.

10. The jewelry article of claim 1, wherein the article possesses a density of about 10 to about 15.00 g/cm³.

11. The jewelry article of claim 1, wherein the composition comprises about 15 wt. % Co, and about 1.5 wt. % Cr.

12. The jewelry article of claim 1, wherein the composition comprises about 20 wt. % Co, and about 2.0 wt. % Cr.

13. The jewelry article of claim 1, further comprising about 0 to about 2% chromium carbide

14. The jewelry article of claim 13, wherein the composition comprises about 22 wt. % Co and about 2.2 wt. % Cr.

15. The jewelry article of claim 13, wherein the composition comprises about 30 wt. % Co and about 3 to about 10.0 wt. % Cr.

16. The jewelry article of claim 13, wherein the composition comprises about 35 wt. % Co, and about 3.5 to about 10.0 wt. % Cr.

17. The jewelry article of claim 1, wherein the composition is substantially free of nickel.

18. The jewelry article of claim 1 wherein the remainder of the composition comprises one or more of: Ta, Nb, Mo, Ti, V, Zr, Hf, Re, Ru, Rh, Os, Ir, Pt, Au and/or Fe.

19. The jewelry article of claim 1, wherein the article is a wedding band.

20. The jewelry article of claim 1, wherein the item of jewelry is a ring, a pendant, a dog tag, a hairclip, a chain, a watchcase, a pin, a bracelet, a necklace, an earring, a personal electronics accessories, or a charm.

21. The jewelry article of claim 1, wherein the item of jewelry is a finger ring.

22. The jewelry article of claim 1, wherein the jewelry article has a hardness value of about 700 to about 1400 HV when measured on a Vickers hardness scale.

23. The jewelry article of claim 1, wherein the article possesses a cracking load of about 700 to about 1000 lbf.

24. The jewelry article of claim 1, wherein the article possesses a “L*” value of about 40 to about 80, an “a*” value of about 0 to about 1.0, and a “b*” value of about 2.0 to about 7.0.

25. The article of claim 1, wherein the article possesses a “L*” value of about 48.5, an “a*” value of about 0.77, and a “b*” value of about 3.7.

26. The jewelry article of claim 1, wherein the article possesses an average grain size of about 1.0 to about 4 μm.

27. The jewelry article of claim 1, wherein the article possesses an average grain size of about 1.4 to about 2.0 μm.

28. The jewelry article of claim 1, wherein the jewelry article is corrosion resistant

29. The jewelry article of claim 1, wherein the article is abrasion resistant.

30. The jewelry article of claim 1 wherein the article can be shattered or cracked by applying pressure from a handheld vice or stationary tool.

31. A method of forming a scratch resistant, high density cemented carbide jewelry article comprising
preparing a cemented carbide that comprises:
cobalt in the amount of about 8 to about 35 wt. %, and
chromium in the amount of about 0.8 to about 3.5 wt. %;
forming a blank of the prepared cemented carbide by subjecting the prepared cemented carbide to pressure in a mold to form the blank; and
sintering the blank with heat for a period of time.

32. The method of claim 31 wherein the prepared cemented carbide comprises about 8 to about 10 wt. % Co and about 0.8 to about 1.0 wt. % Cr.

33. The method of claim 31 wherein the prepared cemented carbide comprises about 10 to about 15 wt. % Co and about 1.0 to about 1.5 wt. % Cr.

34. The method of claim 31 wherein the prepared cemented carbide comprises about 15 to about 20 wt. % Co and about 1.5 to about 2.0 wt. % Cr.

35. The method of claim 31 wherein the prepared cemented carbide comprises about 20 to about 25 wt. % Co and about 2.0 wt. % Cr.

36. The method of claim 31 wherein the prepared cemented carbide comprises about 25 to about 30 wt. % Co and about 2.0 wt. % Cr.

37. The method of claim 31 wherein the prepared cemented carbide comprises about 30 to about 35 wt. % Co and about 2.0 wt. % Cr.

38. The method of claim 31 wherein the prepared cemented carbide comprises about 25 to about 35 wt. % Co and about 2.0 wt. % Cr.

39. The method of claim 31 wherein the prepared cemented carbide comprises about 10 wt. % Co and about 1.0 wt. % Cr.

40. The method of claim 31 wherein the scratch resistant, high density cemented carbide jewelry article possesses a density of about 10 to about 15.00 g/cm³.

41. The method of claim 31 wherein the prepared cemented carbide comprises about 15 wt. % Co and about 1.5 wt. % Cr.

42. The method of claim 31 wherein the prepared cemented carbide comprises about 20 wt. % Co and about 2.0 wt. % Cr.

43. The jewelry article of claim 1 comprising a rare earth element selected from at least one of the following: cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y).

44. The jewelry article of claim 1 comprising a metal selected from at least one of the following:
Actinium, Thorium, Protactinium, Uranium, Neptunium, Plutonium, Americium, Curium, Berkelium, Californium, Einsteinium, Fermium, Mendelevium, Nobelium, and Lawrencium.

45. The jewelry article of claim 1 comprising a metal selected from a transition metal, a lanthaonoid or an actinoid.

46. The jewelry article or component of the jewelry article of claim 1, further comprising a single coating.

47. The jewelry article or component of the jewelry article of claim 1, further comprising a plurality of coatings.
